(19) United States
(12) Patent Application Publication
(10) Pub. No.: US 2026/0359953 A1
(43) Pub. Date: Nov. 12, 2026

(54) Systems and Methods for Real-Time Text Translation Through Inpainting and Textual Data Modification

(71) Applicant: Google LLC, Mountain View, CA (US)

(72) Inventors: Clement Dickinson Wright, Los Angeles, CA (US); Sarah Fay Smith, San Francisco, CA (US); Daniel Paik, San Francisco, CA (US); Darren Kuo, San Carlos, CA (US); Dylan Brandon Kristolaitis, Post Falls, ID (US); Kyle Brien Firth, Sunnyvale, CA (US)

(21) Appl. No.: 19/200,105

(22) Filed: May 6, 2025

(51) Int. Cl. G06T 5/77; G06F 40/58; G06T 7/73; G06T 11/23; G06T 11/60

(52) U.S. Cl. CPC G06T 5/77; G06F 40/58; G06T 7/73; G06T 11/23; G06T 11/60

(57) ABSTRACT

Systems and methods for real-time text translation through inpainting and textual data modification are provided. The system includes performing operations by the one or more processor, the operations include: obtaining display data associated with display content, the display data including: a temporally sequential set of frames; and a first set of textual data in a first language; processing the display data to categorize portions of each frame of the temporally sequential set of frames as a static region or a dynamic region; generating a second set of textual data in a second language based on a subset of the first set of textual data within the static regions of the display data; and augmenting the display data based on the static regions and the second set of textual data by: inpainting portions of the display content; and rendering the second set of textual data in the portions that were inpainted.

### FIELD

The present disclosure relates generally to systems and methods for real-time text translation through inpainting and textual data modification.

### BACKGROUND

Existing translation tools encounter significant latency challenges when performing real-time text translation on user devices, often restricting users to translating individual lines or waiting for extended periods for the translation of the pages to be performed. Consequently, these tools struggle to translate entire web pages, web applications, or other interface elements seamlessly due to latency and computational constraints.

Accordingly, improved systems and methods for real-time translation are desired in the art. In particular, systems and methods for real-time translation that can translate entire web pages, web applications, or other interface elements without reductions in latency would be advantageous.

### SUMMARY

Aspects and advantages of the invention in accordance with the present disclosure will be set forth in part in the following description, or may be obvious from the description, or may be learned through practice of the technology.

One example aspect of the present disclosure is directed to a system for real-time text translation through inpainting and textual data modification is provided. The system includes The system includes performing operations by the one or more processors, the operations include: obtaining display data associated with display content, the display data includes: a temporally sequential set of frames; and a first set of textual data in a first language; processing the display data to categorize portions of each frame of the temporally sequential set of frames as a static region or a dynamic region; generating a second set of textual data in a second language based on a subset of the first set of textual data within the static regions of the display data; and modifying the display data based on the static regions and the second set of textual data by: inpainting portions of the display content including the first set of textual data; and rendering the second set of textual data in the portions that were inpainted.

Another example aspect of the present disclosure is directed to a method for real-time text translation through inpainting and textual data modification is provided. The method includes obtaining, using a computing device, display data associated with display content, the display data includes: a temporally sequential set of frames; and a first set of textual data in a first language; processing, using a first machine-learning model operating on the computing device, the display data to categorize portions of each frame of the temporally sequential set of frames as static regions or dynamic regions, the static regions includes display content that has shifted position across one or more frames within the temporally sequential set of frames while retaining its original content; generating, using the computing device, a second set of textual data in a second language based on a subset of the first set of textual data within the static regions of the display data; and modifying the display data based on the static regions and the second set of textual data by: inpainting portions of the display content including the first set of textual data; and rendering the second set of textual data in the portions that were inpainted.

Another example aspect of the present disclosure is directed to a system for real-time text translation through inpainting and textual data modification is provided. The system includes performing operations by the one or more processor, the operations include: obtaining a first frame descriptive of display content provided for display by a user computing device; obtaining a translation request; processing, using an image augmentation model, the first frame to generate an augmented first frame based on the translation request, processing the first frame includes: identifying a first set of textual data within the first frame; processing the first set of textual data within the first frame to generate a second set of textual data in a language that differs from the first set of textual data; and generating the augmented first frame by replacing the first set of textual data with the second set of textual data; determining a navigation event has occurred based on a change in the display content between the first frame and a plurality of subsequent frames; determining the navigation event has ended based on determining a stagnant state has been reached within a particular frame of the plurality of subsequent frames by analyzing pixel differences across the plurality of subsequent frames based on the change in the display content; obtaining a particular frame from the plurality of subsequent frames when the particular frame occurs after the navigation event ended; processing, using the image augmentation model, the particular frame to generate an augmented particular frame based on the translation request, generating the augmented particular frame includes: identifying a third set of textual data within the particular frame; processing the third set of textual data within the particular frame to generate a fourth set of textual data in a language that differs from the third set of textual data, the second set of textual data and the fourth set of textual data are in a same language; and generating the augmented particular frame by replacing the third set of textual data with the fourth set of textual data.

These and other features, aspects, and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIGS. 1A-B depicts a block diagram of an exemplary system for real-time text translation through inpainting and textual data modification in accordance with exemplary embodiments of the present disclosure;

FIG. 2 is a diagram of an exemplary image patch grid in accordance with embodiments of the present disclosure;

FIG. 3 is an exemplary diagram of real-time text translation through inpainting and textual data modification in accordance with exemplary embodiments of the present disclosure;

FIG. 4 is an exemplary diagram of layers of an exemplary user interface in accordance with exemplary embodiments of the present disclosure;

FIG. 5 is a diagram of an exemplary process for generating the second set of textual data in accordance with exemplary embodiments of the present disclosure;

FIG. 6 is a flow diagram of an exemplary method for real-time text translation through inpainting and textual data modification in accordance with exemplary embodiments of the present disclosure;

FIG. 7 is a flow diagram of an exemplary method for real-time text translation through inpainting and textual data modification in accordance with exemplary embodiments of the present disclosure;

FIG. 8 depicts a block diagram of an exemplary computing system that performs real-time text translation through inpainting and textual data modification according to example embodiments of the present disclosure.

FIG. 9 depicts a block diagram of an exemplary computing system that performs real-time text translation through inpainting and textual data modification according to example embodiments of the present disclosure.

FIG. 10 depicts a flow chart diagram illustrating an example method for training a machine-learned model according to example implementations of aspects of the present disclosure.

FIG. 11 depicts a block diagram of an example processing flow for using machine-learned model(s) to process input(s) to generate output(s) according to example implementations of aspects of the present disclosure.

FIG. 12 depicts a block diagram of an example sequence processing model according to example implementations of aspects of the present disclosure.

FIG. 13 depicts a block diagram of an example technique for populating an example input sequence for processing by a sequence processing model according to example implementations of aspects of the present disclosure.

FIG. 14 depicts a block diagram of an example model development platform according to example implementations of aspects of the present disclosure.

FIG. 15 depicts a block diagram of an example training workflow for training a machine-learned model according to example implementations of aspects of the present disclosure.

FIG. 16 depicts a block diagram of an inference system for operating one or more machine-learned model(s) to perform inference according to example implementations of aspects of the present disclosure.

FIG. 17 depicts a block diagram of an example networked computing system according to example implementations of aspects of the present disclosure.

FIG. 18 depicts a block diagram of an example computing device according to example implementations of aspects of the present disclosure.

FIG. 19 depicts a block diagram of an example computing device according to example implementations of aspects of the present disclosure.

Reference numerals that are repeated across plural figures are intended to identify the same features in various implementations

### DETAILED DESCRIPTION

Generally, systems and methods disclosed herein may be configured to capture and process display data in real time, which can be processed to perform an initial translation rendering for only content currently provided for display. The system can process sequences of frames, and upon determining a subsequent frame is similar to the previous frame that has already been augmented, the system can leverage previous translation outputs and previous inpainting outputs to augment the subsequent frame without performing redundant processing. This display data may be modified by removing the original textual data via inpainting and replacing the original textual data with translated text while preserving the functionality of the user interface.

Additionally and/or alternatively, the system can be configured to continually provide a translation interface throughout navigation requests (e.g., a user scrolling down an interface, a user switching applications, and/or another user navigation action). This may be done by iteratively monitoring the display data to identify stagnant regions. The system may use this information to determine when a new translation is needed (e.g., when a navigation action has ended). In particular, the system may hold off on sending subsequent display data for translation processing until a threshold set of sequential frames is determined to be descriptive of a stagnant state (e.g., the frames are similar and descriptive of navigation coming to a halt).

The disclosed system can enable real-time translation of user interface elements as they appear. By automatically translating text within applications, web pages, and other interface elements, users can interact with content in their preferred language without manual input or delays. Additionally, the overlay application performing the real-time translation can provide translations across the different applications in a seamless manner with relatively low latency.

Existing translation tools can encounter significant latency challenges when performing real-time text translation on user devices, often restricting users to translating individual lines or waiting for extended periods for the translation of the pages to be performed. Consequently, these tools may struggle to translate entire web pages, web applications, or other interface elements seamlessly due to latency and computational constraints. The systems and method disclosed herein can leverage an overlay interface, model inference caching, and rolling stagnation determinations to efficiently provide real-time display content translation with reduced latency and across a plurality of different applications and/or other surfaces. In particular, the systems and methods may utilize an overlay interface implemented at a kernel level of the operating system of the computing device to capture the display content. The overlay interface can determine the presence of text, may transmit the text for translation and the image frame for inpainting, and can then provide an augmented frame with translated text rendered in place of the original text. The model inferences including the text translations and the inpainting prediction (e.g., the background pixel predictions) may be stored in a cache to be leveraged for subsequent frames that depict at least a portion of the already processed display content. The systems and methods can then perform pixel diffing on a rolling basis to determine when a new translation and new inpainting prediction is to be performed. The pixel diffing may be utilized to determine when and/or to what extent a transition from using cached inferences to perform new inferences is to be performed.

Additionally and/or alternatively, the pixel diffing may be utilized to determine when a navigation has begun and ended. Translating and rendering throughout a navigation action can be computationally expensive. The systems and methods may hold off on translating and augmenting subsequent frames until a stagnant state is reached. Once a stagnant state is reached, the text translation and image augmentation may resume. The process can reduce latency, while saving on computational cost of real-time translation.

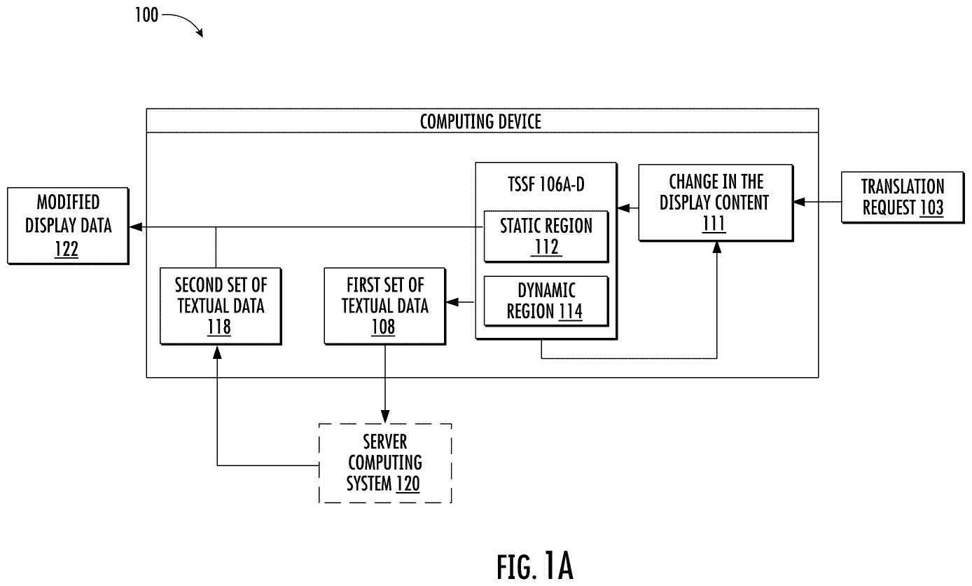

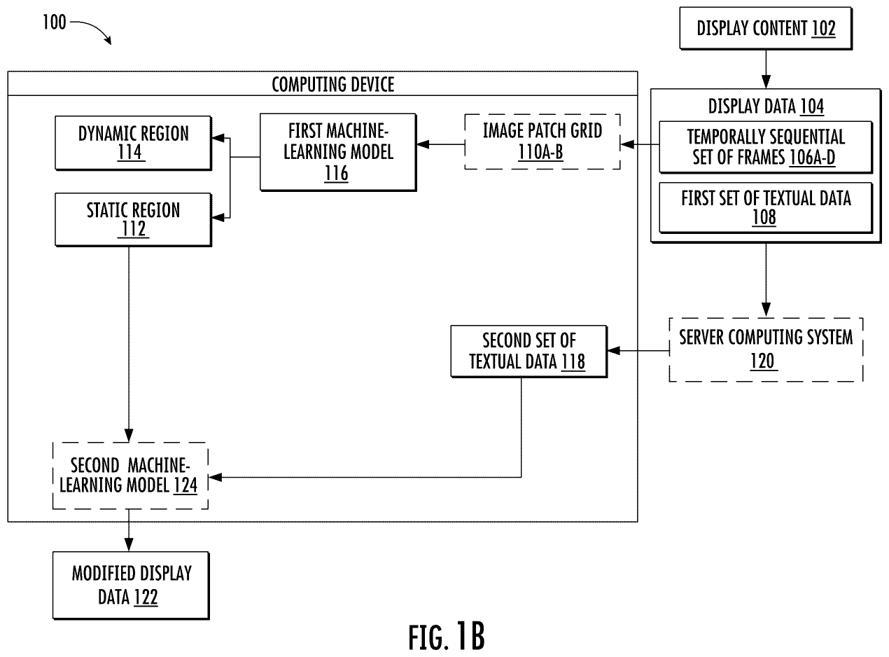

Referring now to the drawings, FIGS. 1A-B illustrates an exemplary system for real-time text translation through inpainting and textual data modification in accordance with exemplary embodiments of the present disclosure. System 100 includes display content 102, display data 104, a temporally sequential set of frames (TSSF) 106A-D, a first set of textual data 108, image patch grid 110A-B, static regions 112, dynamic regions 114, a first machine-learning model 116, a second set of textual data 118, a server computing system 120, modified display data 122, a second machine learning model 124, and the like.

The operations may include obtaining a translation request 103. As used in the current disclosure, translation request 103 is an input or signal received by the system to initiate the real-time translation process for textual content displayed on a user interface. This request may originate from a user and can be triggered through various forms of interaction, such as tapping a specific button, selecting text, performing a gesture (e.g., long-press or swipe), or issuing a voice or keyboard command. The translation request 103 may serve as an instruction to the system, indicating that the user wishes to have a portion or all of the on-screen textual content translated from a first language to a second language. Upon receiving the translation request 103, the system begins a sequence of operations designed to analyze and translate the current display data. These operations may include any operations disclosed herein. In certain implementations, the translation request 103 may also specify preferences such as the target language, the scope of translation (e.g., full page vs. selected text), or the desired format of the translated content.

With continued reference to FIGS. 1A-B, the operations can include obtaining display data 104 associated with display content 102. The display data can be descriptive of information that represents visual content that is displayed by an underlying user interface. Display data 104 may include information that visually represents the content shown on the underlying user interface. This may include visual data associated with web pages, applications, device operating systems, and the like. The process of obtaining display data 104 may involve capturing, retrieving, or generating information that corresponds to the underlying display content 102. This may occur through various methods, such as direct rendering, screen capturing, or data extraction from system components that manage the user interface.

The display data 104 may include a temporally sequential set of frames 106A-D. As used in the current disclosure, the temporally sequential set of frames (TSSF) refers to a series of images or snapshots captured over time, each representing different moments or perspectives of an underlying user interface. The TSSF 106A-D may represent a structured series of images or snapshots captured over time, each corresponding to a different moment or visual state of an underlying user interface. Each frame within the TSSF 106A-D may be used to capture a specific portion of the display content 102 at a distinct point in time.

The TSSF 106A-D may include a zeroth frame, a first frame 106A, a second frame 106B, a third frame 106C, a fourth frame 106D, up to and including an Nth frame. Each of these frames may be temporarily sequential in nature. For example, the first frame 106A may be the earliest frame, whereas the second frame 106B is captured at a predetermined time interval after the first frame 106A. This process may be iteratively repeated during the live text translation process. The predefined intervals may range between 5 milliseconds (ms) and 100 milliseconds (ms).

In an embodiment, the display data 104 may include a first set of textual data 108. As used in the current disclosure, the first set of textual data can include any textual content that appears within the temporally sequential set of frames (TSSF). This text may include visible user interface elements such as menu labels, buttons, notifications, form inputs, status messages, and dynamically generated content displayed within the captured frames.

The first set of textual data 108 may be tied to the temporally sequential set of frames 106A-D of the display content 102. As the display content 102 evolves (e.g. user interactions, interface updates, scrolling, or animations), the textual data within each frame may change accordingly. The system may employ optical character recognition (OCR), metadata extraction, or direct data retrieval from the interface to obtain and process the textual content embedded within the frames.

The first set of textual data 108 may represent the text in a first language. Where the first language may include, but is not limited to, languages such as English, Mandarin Chinese, Hindi, Spanish, French, Arabic, Bengali, Russian, Portuguese, Urdu, Indonesian, German, Japanese, Swahili, Marathi, Telugu, Turkish, Korean, Tamil, Vietnamese, Hausa, and the like. The first language may include any language and may not be limited to the list above. In some implementations, the first set of textual data may include multiple different languages that may be identified and translated to a single language based on the systems and methods disclosed herein.

In an embodiment, system 100 may include a third set of textual data. The third set of textual data may be the same as or substantially similar to the first set of textual data 108, even though it is associated with a subsequent frame within the temporally sequential set of frames.

Obtaining the display data 104 may include processing the temporally sequential set of frames (TSSF) 106A-D to extract the first set of textual data 108. To achieve this, System 100 may utilize optical character recognition (OCR) or other text extraction techniques to identify and convert the visible text within the frames into machine-readable data. OCR may work by analyzing patterns within an image to detect characters, words, and phrases. In some cases, OCR may incorporate machine learning and artificial intelligence to enhance recognition accuracy, enabling the system to identify various fonts, sizes, and even handwritten text.

Processing the TSSF 106A-D may involve identifying specific regions within each frame that contain text. Rather than scanning the entire image indiscriminately, system 100 may employ region of interest (ROI) detection, which focuses on areas where text is most likely to appear. These regions may include buttons, labels, menus, descriptions, and pop-up notifications. By narrowing the search area, the system may reduce computational overhead and improve latency by minimizing interference from non-textual graphical elements.

With continued reference to FIGS. 1A-B, the operations may include processing the display data to generate an image patch grid 110A-B associated with the temporally sequential set of frames. As used in the current disclosure, the image patch grid 110A-B may be a structured division of a frame into smaller regions, or cells. The image patch grid may be used to facilitate more granular processing and analysis of the display data 104. The image patch grid 110A-B may be generated by segmenting the display data 104 into a plurality of smaller, uniform sections, enabling systematic examination of the temporally sequential set of frames 106A-D. By applying the image patch grid 110A-B across the TSSF 106A-D, the system can track changes at a localized level over time. For example, the system can monitor how specific interface elements such as buttons, icons, or text fields evolve across multiple frames.

To generate the image patch grid 110A-B, the system processes the display data 104 by dividing each frame into a structured grid layout, where each cell represents a specific portion of the interface at a given moment. This structured segmentation allows the system to focus on individual sections of the display content 102 rather than processing the entire frame at once. This method may be particularly useful for optimizing optical character recognition (OCR), region of interest (ROI) detection, and the like, as it enables targeted examination of different elements within the interface.

In an embodiment, there may be a first subset of cells associated with each frame within the TSSF 106A-D. For example, the first subset of cells 110A may be associated with the first frame 106A and the first subset of cells 110B may be associated with the second frame 106B.

With continued reference to FIGS. 1A-B, system 100 may detect a change 111 in the display content 102 by continuously analyzing incoming frames within the TSSF 106A-D for visual differences. These differences may be identified using image diffing techniques such as pixel-wise comparison, optical flow analysis, structural similarity indexing (SSIM), and other visual change detection algorithms discussed below. By comparing each newly received frame to one or more preceding frames, system 100 can identify shifts in pixel values, layout adjustments, or newly rendered elements that signify updates to the on-screen content.

Upon detecting the change 111, system 100 may initiate or continue the process of identifying static regions 112 and dynamic regions 114 within the display content 102. The detection of new or altered content may indicate that previous classifications of certain regions are no longer valid, prompting re-evaluation.

In response to detecting a change 111, system 100 may also continue or restart the real-time translation process. This may involve isolating newly rendered textual data within the identified static regions 112 and preparing it for translation. If textual data has shifted position but remains visually consistent, system 100 may remap the previously translated content to its new location. Alternatively, if entirely new textual content is detected, it may be extracted, processed, and transmitted to a translation engine or server computing system for conversion into a second language.

With continued reference to FIGS. 1A-B, the operations include processing the display data 104 to categorize portions of each frame of the temporally sequential set of frames 106 A-D as a static region 112 or a dynamic region 114. As used in the current disclosure, a static region 112 of a frame refers to an area of the display content 102 that is stable or unchanged across multiple frames within the TSSF 106 A-D. Static regions 112 may include portions of the display content for which the pixel values remain within a predetermined threshold across two or more frames within the TSSF 106A-D. These static regions 112 may be characterized by visual stability, meaning that despite potential changes in surrounding content or user interaction, the pixel-level information in these areas exhibits minimal variation over time. Static regions 112 may include display content 102 and/or UI components such as persistent text, background images, fixed buttons, or structural elements that remain visually consistent throughout different frames.

In some cases, a static region 112 may not necessarily stay in the same position within each frame but instead, shift locations while maintaining its content. For instance, if a first frame 106A includes static text positioned at the bottom of the display and a second frame 106B shows the same text at the top, both the bottom area of the first frame 106A and the top area of the second frame 106B may be classified as static regions. This can be done because the text itself remains unchanged, even though its position has shifted. By recognizing these positional adjustments, the system can accurately differentiate between content modifications (dynamic regions 114) and repositioned but unchanged elements (static regions 112.)

In contrast, a dynamic region 114 of a frame may include an area within the display content 102 that undergoes changes across multiple frames in the temporally sequential set of frames (TSSF) 106A-D. Dynamic regions 114 may contain elements that evolve over time, either through content modifications, animations, or user interactions. These changes may involve text updates, videos, moving objects, pop-up elements, scrolling content, and interactive UI components that alter their appearance, position, or structure between frames.

To categorize portions of each frame in the TSSF 106A-D, system 100 may employ a first machine-learning model 116. As used in the current disclosure, the first machine-learning model 116 is an image-diffing model designed to categorize portions of the frames within the TSSF 106A-D. The first machine-learning model 116 may be trained to detect, classify, and differentiate between static regions 112 and dynamic regions 114 within the display content 104. This may be done by comparing, analyzing, or evaluating the content of the cells within the image patch grid 110A-B. The first machine-learning model 116 may employ computer vision and deep neural networks to analyze pixel-level variations, structural patterns, text changes, and motion cues across frames. The first machine-learning model 116 may employ convolutional neural networks (CNNs), recurrent neural networks (RNNs), or transformer-based architectures to classify, and differentiate between static regions 112 and dynamic regions 114.

The first machine-learning model 116 may be configured to facilitate an image diffing process to categorize portions of each frame within TSSF 106A-D as either static region 112 or dynamic region 114. This process may involve comparing consecutive frames within the TSSF 106A-D to detect visual changes. This may be done using image diffing techniques that operate by analyzing pixel-level differences, tracking movement, and applying feature-matching algorithms to determine whether observed changes are true content updates or merely positional shifts of static elements.

To determine whether a region qualifies as a static region 112, the system may perform a pixel-wise comparison across corresponding areas in multiple frames. In this process, each pixel in a selected region of a frame 106A-D may be compared to the corresponding pixel in the same region of a subsequent frame. The comparison may be based on the absolute difference in pixel values, such as RGB or luminance intensity. If the difference falls within a predefined threshold for a sufficient number of pixels in the region, the system considers the region as a static region 112. This threshold can be tuned to accommodate minor variations due to compression, rendering artifacts, or anti-aliasing, ensuring that truly static content is not misclassified as dynamic.

The first machine-learning model 116 may assist in this pixel-wise analysis by learning patterns of stability and motion across frame sequences. Rather than relying solely on raw pixel comparisons, the model may incorporate additional contextual information, such as edge continuity, texture similarity, and spatial coherence, to more accurately determine static regions. For example, the first machine-learning model 116 may be trained using supervised or unsupervised learning techniques to recognize regions that typically remain constant in common user interfaces, such as navigation bars or headers. By applying learned representations, the model improves the robustness of static region classification even under conditions where pixel values slightly fluctuate due to rendering or visual noise.

The first machine-learning model 116 may optimize the comparison process by predicting which areas of the frame are likely candidates for static classification before detailed pixel-wise comparison is performed. This prioritization can reduce computational load and can enable real-time responsiveness, particularly useful in applications such as real-time translation or augmented user interfaces.

In some cases, the first machine-learning model 116 may go beyond simple pixel comparisons by incorporating optical flow analysis and spatiotemporal feature recognition to determine whether a detected change corresponds to a true modification in content (such as new text appearing, a video playing, or an animation playing) or a motion-based transformation (such as scrolling, where content remains unchanged but shifts position). By distinguishing between these cases, the system may distinguish between static elements that move across frames and genuinely changing content.

The segmentation of the TSSF 106A-D into the image patch grid 110 may allow the first machine-learning model 116 to focus on smaller, more manageable regions, rather than processing the entire frame at once. Each cell of the image patch grid 110 may be analyzed for visual features such as color distribution, texture patterns, text regions, and object contours. Once the visual features are evaluated, the first machine-learning model 116 may compare the cells to corresponding cells across multiple frames of the TSSF 106A-D to determine their stability over time. Cells that exhibit minimal or no changes across sequential frames are grouped into the first subset of cells, representing static regions 112.

For cells that exhibit visual variations across frames, the first machine-learning model 116 may evaluate the nature of these changes to determine whether they should be categorized as dynamic regions 114. Cells that show structural transformations, UI elements appearing/disappearing, or animated effects are placed in the second subset of cells, representing the dynamic regions 114.

The first machine-learning model 116 may be designed to identify instances where a portion of text moves due to scrolling but retains its content, formatting, and structure. This may be done with the goal of classifying these portions of text as part of a static region 112 rather than a dynamic region 114. When analyzing the TSSF 106A-D, the first machine-learning model 116 may examine whether the text remains unchanged in terms of characters, font, and appearance, even as its position shifts across frames. By incorporating optical flow analysis and pattern recognition, the first machine-learning model 116 can differentiate between true content modifications, such as text updates or replacements, and positional shifts caused by user interactions, such as scrolling. This distinction allows the system to accurately classify persistent text as static, ensuring that movement alone does not trigger unnecessary reclassification.

To achieve this, system 100 may employ one or more motion tracking algorithms that distinguish between deliberate UI transitions, like scrolling, and random pixel fluctuations that do not indicate meaningful content changes. When a user scrolls through a web page or application, text elements may shift within the frame but remain visually identical. Instead of mistakenly detecting this movement as a dynamic change, the first machine-learning model 116 may be configured to track the displacement of text across sequential frames. By recognizing that the content itself remains consistent, the model correctly classifies it as part of a static region 112 within the first subset of cells in the image patch grid 110A-B.

With continued reference to FIGS. 1A-B, the operations further include generating a second set of textual data 118 in a second language based on a subset of the first set of textual data 108 within the static regions 112 of the display data 104. The second set of textual data 118 may be a translation of the first set of textual data 108 into the second language while ensuring that its meaning, context, and formatting are preserved. This process may be carried out using one or more machine translation models, which analyze the extracted text and produce an equivalent representation in the target language.

System 100 may incorporate a machine translation model that is configured to perform both language detection and translation on textual data extracted from the TSSF 106A-D. These machine translation models may be the same or substantially similar to other models disclosed herein. When a frame is received, the machine translation model may isolate segments of textual content residing in static regions 112.

The machine translation model may also be used to translate the textual content from the first language into a second language. The translation may preserve semantic meaning, context, tone, and domain-specific terminology, ensuring that the output is both accurate and readable within the user's interface. Depending on the complexity of the textual content, the machine translation model may also support formatting, grammar corrections, and phrase restructuring to create a coherent and localized translation suitable for overlay on the modified display data.

The machine translation model used for detection and translation may be deployed locally on system 100 or reside within a remote server computing system 120. As used in the current disclosure, the server computing system 120 is a centralized computing infrastructure designed to handle computationally intensive tasks such as neural machine translation (NMT). The server computing system 120 may consist of one or more physical or virtualized servers operating in a cloud-based or on-premises environment. These servers may be equipped with high-performance CPUs, GPUs, or TPUs to optimize the performance of deep learning models. The server computing system 120 may also leverage parallel computing frameworks and distribute processing to handle multiple translation requests simultaneously to ensure real-time or near-real-time performance.

In some cases, the system may select a subset of the first set of textual data 108 within the static regions 112 of the display data 104 to optimize translation efficiency and processing speed. System 100 may evaluate the textual data within the static regions 112 to determine which text elements are most relevant for translation. This evaluation may include natural language processing (NLP) techniques such as text saliency analysis, language detection, and keyword extraction. System 100 may prioritize textual elements based on factors such as visibility, font size, position within the interface, and semantic importance. For instance, header text or user-facing instructions may be selected over background text or system-generated metadata.

To further refine the subset selection, the system may incorporate user context or interaction history. For example, if a user has previously engaged with specific interface elements, such as buttons, menus, or forms, the system may prioritize the translation of associated text. Additionally, the system may track which regions of the screen the user focuses on, either through touch input, scroll behavior, or eye-tracking technologies, if available.

The process of generating the second set of textual data 118 may include transmitting the subset of the first set of textual data 108 from system 100 to the server computing system 120. Upon receiving the textual data, the server computing system 120 may perform a plurality of pre-processing tasks, such as text normalization, tokenization, language identification, and the like. Once the text is preprocessed, system 100 may instruct the server computing system 120 to apply a machine translation model trained on extensive multilingual datasets. This machine translation model may utilize a transformer-based architecture, such as those found in NMT frameworks, which employ attention mechanisms to analyze word dependencies and contextual relationships across different languages. By leveraging deep learning techniques, the machine translation model can generate a second set of textual data 118 that preserves the meaning, tone, and intent of the first set of textual data 108, ensuring that the translation is both linguistically and contextually accurate.

Once the translation is complete, system 100 may instruct the server computing system 120 to transmit the second set of textual data 118 back to system 100. Upon receiving the translated text, system 100 may store, process, or integrate it into the appropriate user interface, document, or application.

The second language may include, but is not limited to, English, Mandarin Chinese, Hindi, Spanish, French, Arabic, Bengali, Russian, Portuguese, Urdu, Indonesian, German, Japanese, Swahili, Marathi, Telugu, Turkish, Korean, Tamil, Vietnamese, Hausa, and many others. The second language may include any language and may not be limited to the list above. In some implementations, the second set of textual data may include a translation of multiple different languages that appear in the first set of textual data into a single language based on the systems and methods disclosed herein.

In an embodiment, system 100 may include a fourth set of textual data. The fourth set of textual data may be the same as or substantially similar to the second set of textual data 118, even though it is associated with a subsequent frame within the temporally sequential set of frames.

With continued reference to FIGS. 1A-B, the operations may include comparing the static regions 112 of each frame in the temporally sequential set of frames 106A-D. This comparison process may be configured to evaluate whether the static regions 112 of the first frame 106A remain consistent with those of the second frame 106B. This may be done to facilitate the mapping and comparison of persistent elements across frames.

The comparison process may include an analysis of the first subset of cells 110A from the first frame 106A and comparing them to the first subset of cells 110B associated with the second frame 106B. Each cell within the image patch grid 110A-B may represent a discrete portion of the display content 102. This comparison of the cells may facilitate the mapping of static regions 112 across frames, even if these regions have moved due to interactions like scrolling.

System 100 may map each cell from the first subset of cells 110A of the first frame 106A to a corresponding cell in the first subset of cells 110B of the second frame 106B. This mapping may facilitate tracking of the static content across frames. The mapping process may involve systematically aligning each cell within the first subset of cells 110A with its corresponding cell within the first subset of cells 110B.

To perform this mapping, System 100 may employ a range of machine learning techniques, such as feature-matching algorithms, optical flow analysis, and spatial transformation techniques. These techniques may be used to detect positional changes of static elements between frames. Each cell within the image patch grid 110A-B may contain visual information that can be analyzed for unique patterns, colors, text, and structural elements. System 100 may analyze and evaluate the visual elements of each cell in the first subset of cells 110A using image processing techniques like edge detection, text recognition, and pixel similarity metrics. These visual elements may then be compared to corresponding cells in the first subset of cells 110B based on the mapping.

In cases where the content remains unchanged but has shifted position, such as during scrolling, one or more optical flow techniques may be employed to estimate the movement of visual elements across frames. Optical flow algorithms may be used to evaluate pixel displacement and motion vectors to determine the direction and magnitude of movement for each cell. This information may allow system 100 to realign static content from the first frame 106A to the second frame 106B, ensuring that each cell in the first frame 106A is mapped to its most accurate counterpart in the second frame 106B.

System 100 may proceed with the comparison based on the mapping; the comparison is used to evaluate whether the mapped cells retain the same visual content. During this comparison, the system may evaluate each mapped cell to determine whether its visual content remains unchanged between frames. This evaluation may include pixel-based analysis, feature extraction, and machine learning-based image diffing to detect any variations.

System 100 may compare the visual elements of each cell in the first subset of cells 110A using image processing techniques such as edge detection, text recognition, and pixel similarity metrics. These methods extract and evaluate visual elements from each cell, such as shapes, text, pixels, color patterns, and the like. Once these visual elements are extracted, they are compared to the corresponding cells in the first subset of cells 110B based on the established mapping between frames. This comparison helps to identify any changes or consistencies in the visual content, ensuring that static regions 112 remain correctly identified, even if slight positional shifts have occurred between frames.

With continued reference to FIGS. 1A-B, the operations include modifying the display data 122 based on the static regions 112 of each frame and the second set of textual data 118. As used in the current disclosure, modified display data 122 refers to a frame or set of frames that have been modified by overlaying, inserting, or altering visual elements. The modified display data 122 may also be referred to as an augmented frame. The augmentation/modification of the display data may include mapping static regions 112 across multiple frames, inpainting the static regions 112 of the frames that depict textual data and rendering the textual data in a second language in place of the inpainted textual data. The augmentation/modification process may be initiated when the system detects that portions of the display content 102, such as the first set of textual data 108, need to be translated into the second language. This detection may be made based on the comparison of the visual elements of static regions 112 across two or more frames within the TSSF 106A-D. The comparison of the visual elements of static regions 112 may be enacted using any comparison techniques described herein.

The process of generating the modified display data 122 may include identifying static regions 112 of each frame in the TSSF 106A-D where the first set of textual data 108 appears. Once identified, the translated text (second set of textual data 118) may be used to inpaint the original text in the corresponding portions of the display content 102. Inpainting algorithms can be employed by the second machine learning model 124 to integrate the translated text into the layout of the frame, ensuring that the translated content fits naturally within the display, preserving the visual flow and consistency of the interface.

To facilitate real-time translation, system 100 may inpaint the second set of textual data 118 in the same areas where the original text was located, ensuring that the transition between languages occurs smoothly without disrupting the user interface. The modified display data 122 may also account for language-specific formatting adjustments, such as font size, text direction, and spacing, to accommodate the characteristics of the translated text.

Modifying the display data 122 may include mapping each cell from the first subset of cells 110A of the first frame 106A to a corresponding cell in the first subset of cells 110B of the second frame 106B. This mapping may facilitate tracking of the static content across frames. The mapping process may involve systematically aligning each cell within the first subset of cells 110A with its corresponding cell within the first subset of cells 110B.

To perform this mapping, System 100 may employ a range of machine learning techniques, such as feature-matching algorithms, optical flow analysis, and spatial transformation techniques. These techniques may be used to detect positional changes of static elements between frames. Each cell within the image patch grid 110A-B may contain visual information that can be analyzed for unique patterns, colors, text, and structural elements. System 100 may analyze and evaluate the visual elements of each cell in the first subset of cells 110A using image processing techniques like edge detection, text recognition, and pixel similarity metrics. These visual elements may then be compared to corresponding cells in the first subset of cells 110B based on the mapping.

In cases where the content remains unchanged but has shifted position, such as during scrolling, one or more optical flow techniques may be employed to estimate the movement of visual elements across frames. Optical flow algorithms may be used to evaluate pixel displacement and motion vectors to determine the direction and magnitude of movement for each cell. This information may allow system 100 to realign static content from the first frame 106A to the second frame 106B, ensuring that each cell in the first frame 106A is mapped to its most accurate counterpart in the second frame 106B.

System 100 may compare the visual elements of each cell in the first subset of cells 110A using image processing techniques such as edge detection, text recognition, and pixel similarity metrics. These methods extract and evaluate visual elements from each cell, such as shapes, text, pixels, color patterns, and the like. Once these visual elements are extracted, they are compared to the corresponding cells in the first subset of cells 110B based on the established mapping between frames. This comparison helps to identify any changes or consistencies in the visual content, ensuring that static regions 112 remain correctly identified, even if slight positional shifts have occurred between frames.

In an embodiment, the modified display data 122 may be generated by a second machine learning model 124. As used in the current disclosure, the second machine learning model 124 is a model designed to handle the transformation and rendering of visual content on the display based on dynamic inputs or updates. The second machine learning model 124 may be used to apply modifications that allow the system to translate the display content 102 in real-time. The second machine learning model 124 may include any image augmentation model disclosed herein.

The second machine learning model 124 may be responsible for generating the modified display data 122 by dynamically inpainting or rendering textual and visual elements within the frame. Specifically, when a portion of the display content 102 needs to be replaced, modified, or updated, the second machine learning model 124 may be configured to inpaint the second set of textual data 118 into the frame. The second machine learning model 124 may be configured to execute a plurality of tasks such as determining the appropriate spatial placement for new text or UI elements, adjusting for language-specific characteristics (like text direction, length, or font size), and maintaining visual consistency across the interface. The second machine learning model 124 could use techniques like neural style transfer, generative adversarial networks (GANs), or content-aware inpainting to generate these adjustments smoothly.

The second machine learning model 124 can be trained on a variety of visual data sources, such as annotated UI designs, user behavior data, and linguistic data, to understand how different changes in the interface should be handled. The model may be capable of handling language-specific nuances, content scaling, and real-time adaptation to ensure that the system can modify and render the display in a way that is both accurate and visually coherent.

In an embodiment, modifying the display data 104 may include processing the first set of textual data 108 to generate a formatting parameter for each textual datum within the set. System 100 may be configured to analyze the original text's appearance, style, and structure to extract key attributes that define its formatting. For each textual datum, the system may capture essential parameters, such as font type, size, color, line spacing, text alignment, and any specific formatting features like bold, italics, or underlining. Additionally, System 100 may also consider contextual factors like paragraph breaks, bullet points, or any other visual cues that influence the presentation of the text.

Once the formatting parameters for the first set of textual data 108 are identified, the system may apply these parameters to the second set of textual data 118. This may be done to depict the translated text with the same visual style and layout as the original text, accounting for language-specific differences that might impact the formatting. For instance, languages such as Arabic or Hebrew may require right-to-left text alignment, while other languages might have longer or shorter text, which could necessitate adjustments to font size or line breaks. By applying the generated formatting parameters to the translated text, the system maintains visual consistency across frames, preventing disorienting changes that could confuse users or negatively impact the user experience.

In some cases, system 100 may employ the image and language processing techniques of the second machine learning model 124 to identify and apply the formatting parameters. For example, the second machine learning model 124 may leverage optical character recognition (OCR) to extract the formatting details from the first set of textual data 108, followed by feature-matching algorithms to associate these details with corresponding portions in the second set of textual data 118. The system may also account for differences in language structure. The application of these formatting parameters ensures that when the second set of textual data 118 is rendered, it appears as closely aligned to the first set of textual data 108 as possible, preserving the overall integrity of the user interface, readability, and aesthetic design.

In some embodiments, the real-time translation features discussed herein may operate in a persistent, always-on state, continuously translating on-screen content as a user navigates throughout a single webpage, across multiple webpages, even between entirely different applications and UI elements. Rather than requiring manual reactivation or repeated translation requests 103, system 100 may remain in an active state, continuously monitoring the display content 102 for newly rendered or updated textual data in a first language.

As the user scrolls through a webpage, clicks through menus, opens dialogs, or switches tabs or applications, System 100 may automatically identify and process any textual content rendered as part of the updated display data 102. This processing may include classifying display regions as static or dynamic, isolating textual content from static regions 112, and translating the content into a second language in real time, without interrupting the user's interaction with the onscreen environment.

Upon receiving a translation request 103, system 100 may begin monitoring for changes 111 in the display data 102, performing real-time translation in response to user interactions or system events. These interactions may include, but are not limited to, tapping on the screen, scrolling, clicking items, switching between apps, or interacting with UI components such as dropdowns, modals, and popups. Each of these navigation events may lead to the rendering of new or updated content, triggering a new translation instance.

System 100 may evaluate the updated display content 102 to determine whether previously translated static regions 112 persist, have shifted, or if new static regions have appeared. The system may utilize image diffing and machine learning models to maintain continuity, mapping prior translations to their appropriate new positions. In some embodiments, the system may cache translations, pre-process anticipated text regions, or apply predictive modeling to reduce latency and ensure that translated content is rendered promptly as the user navigates and interacts with the interface.

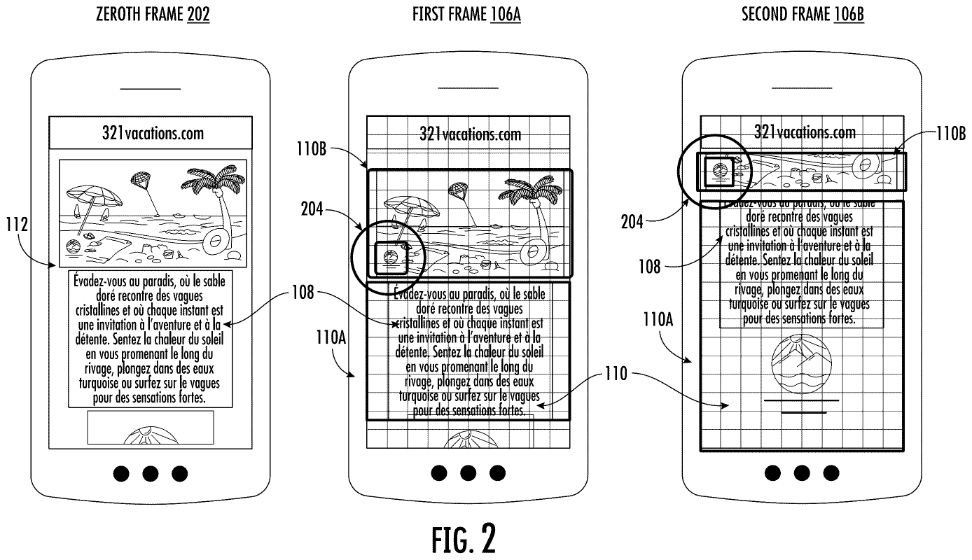

Referring now to FIG. 2, a diagram of an exemplary image patch grid in accordance with embodiments of the present disclosure.

System 200 may process the zeroth frame 202 as an initial step in analyzing and tracking display content. This process includes registering the zeroth frame 202 for callback and generating the image patch grid 110. Registering the zeroth frame 202 may be done to establish a baseline representation of the display content 102, enabling the system to compare subsequent frames against this reference. The registration process may involve capturing the full-frame image data, extracting relevant metadata, and storing key attributes such as resolution, aspect ratio, and the structural composition of visual elements within the frame.

Once the zeroth frame 202 is registered, the system may generate the image patch grid 110 by dividing the frame into structured segments or cells. This decomposition allows for detailed analysis, making it easier to detect changes, track persistent elements, and apply modifications where needed. The image patch grid 110 generation process may involve defining a fixed grid size based on the display resolution, dynamically adjusting cell dimensions based on content density, or using adaptive segmentation techniques to optimize grid allocation. Each cell within the grid may be assigned a unique identifier, allowing the system to track its corresponding content across multiple frames. The image patch grid 110 may be generated using methods similar to those described in FIGS. 1A-B.

After generating the image patch grid 110, the system classifies each cell into a first subset of cells 110A or a second subset of cells 110B based on their visual characteristics and consistency across frames. This classification may employ image diffing techniques such as pixel-wise comparison, structural similarity analysis (SSIM), optical flow estimation, and feature-based matching. The first subset of cells 110A includes static regions 112, which may include persistent UI elements, background graphics, unchanged text, and the like. Conversely, the second subset of cells 110B may include dynamic regions 114, where content frequently changes due to animations, video playback, or user-driven updates.

In some cases, a third subset of cells 204 may be identified within the image patch grid 110, representing semi-static regions. These semi-static regions may exhibit partial or occasional changes across frames, such as an icon or logo that remains mostly unchanged within a video or animated background. To classify these cells accurately, the system may use image diffing techniques that analyze temporal patterns of change, distinguishing between minor fluctuations and significant content modifications. By recognizing semi-static regions, the system can optimize processing efficiency, selectively refreshing these areas based on detected changes rather than performing unnecessary updates. The third subset of cells 204 may be identified using any method described herein for the classification of regions of cells.

The classification of the third subset of cells 204 may be used to improve the balancing accuracy and computational efficiency of the second machine-learning model 124. Unlike fully static cells in the first subset 110A, which require minimal reprocessing, or dynamic cells in the second subset 110B, which need frequent updates, the third subset of cells 204 is refreshed only when necessary. The identification of the third subset of cells 204 may allow the second machine-learning model 124 to focus on updates for elements that require them while minimizing computational overhead, resulting in smoother performance and improved resource management.

For example, FIG. 2 depicts a website displaying a video or moving graphic alongside text in a first language describing the visual content. The system may classify the areas of the frame containing the video as dynamic regions 114, assigning them to the second subset of cells 110B. Meanwhile, the areas of the frame containing static text may be classified as static regions 112, corresponding to the first subset of cells 110A. However, if the video contains a static logo that remains unchanged, the system may classify this portion of the video as a semi-static region, placing it in the third subset of cells 204. This classification can enable the system to differentiate between elements requiring continuous updates and those that can be selectively processed, improving overall efficiency.

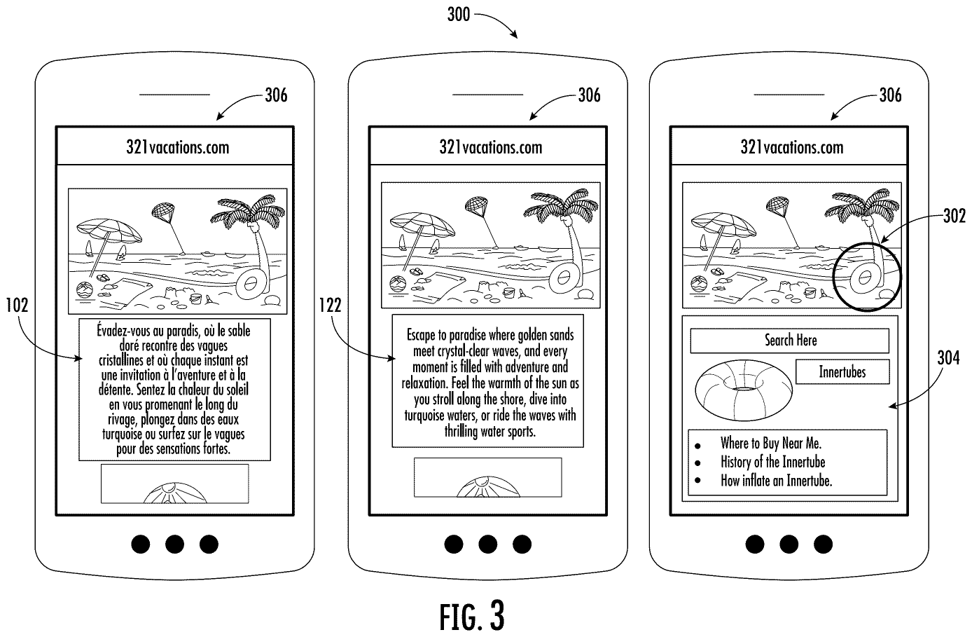

Referring now to FIG. 3, an exemplary diagram of real-time text translation through inpainting and textual data modification in accordance with exemplary embodiments of the present disclosure.

The process of inpainting the display data 104 to generate modified display data 122 may include selectively filling in or replacing portions of the display content 102 to facilitate modifications to the display content 102, such as real-time text translation. Inpainting the display data 104 may include identifying areas within the display data 104 that require inpainting, such as regions containing the first set of textual data 108. Using the second machine learning model 124, the system may be configured to remove or obscure the original text while preserving the surrounding visual context. The second machine learning model 124 may leverage various inpainting techniques such as texture synthesis, or diffusion-based approaches to reconstruct background elements with high fidelity. Once the original text is removed, the system may modify the display data 122 by overlaying the second set of textual data 118 in its place. In some cases, this overlaying may include formatting the second set of textual data 118 similarly to the first set of textual data 108 based on the formatting parameter. This formatting may include things like alignment, font style & consistency, and overall adherence to the original formatting parameters.

In an embodiment, the operations may include receiving a user inquiry 302 associated with at least one frame within the temporally sequential set of frames. As used in the current disclosure, a user inquiry 302 refers to an input provided by a user to request additional information, perform a search, or trigger a specific action related to at least one frame within the temporally sequential set of frames. The user inquiry 302 may serve as an interactive mechanism through which users can engage with the displayed content by highlighting, selecting, or otherwise indicating areas of interest within a frame.

The user inquiry 302 may be provided through various input modalities, including textual, verbal, or tactile interactions. For instance, a user may submit a textual query by typing keywords related to a specific portion of the displayed content, or they may provide a verbal command processed via speech recognition to initiate a search or retrieve additional details. In a touch-enabled interface, the user may circle, highlight, or tap on a region of the frame to specify an area of interest.

Once the user inquiry 302 is received, the system processes the input by analyzing the designated area or extracting relevant contextual data from the frame. This may include identifying textual content within the selected region, detecting objects, or recognizing UI elements. The system may then perform a corresponding operation, such as searching a database for related information, retrieving translations, providing definitions, or linking the user to additional resources.

With continued reference to FIG. 3, the operations may include generating a query response 304 based on the user inquiry 302. As used in the current disclosure, the query response 304 refers to the information retrieved or generated based on a user inquiry 302. The query response 304 may provide relevant results or further exploration based on the user inquiry 302. Depending on the nature of the inquiry, the response may include direct answers, a list of related results, suggested refinements, or prompts for additional input. The query response 304 may be generated using contextual analysis, database lookups, or external data retrieval processes. In some cases, the query response 304 may present a ranked set of possible matches, highlighting the most relevant results based on factors such as similarity, relevance, or contextual alignment with the user inquiry. If the initial response lacks sufficient specificity, the system may refine the output by suggesting alternative queries, narrowing the scope, or prompting the user for more details.

In certain embodiments, the query response 304 may include interactive elements, such as expandable sections, preview snippets, or links to deeper content. This may allow users to explore related information efficiently and refine their focus as needed.

In response to a user inquiry, the system may generate an image segment from at least one frame within the temporally sequential set of frames 106A-D. An image segment may be a cropped or isolated visual region of interest within a frame that directly corresponds to the user's selection, such as a circled object, highlighted text, or tapped UI element. This image segment may serve as the focal point for further processing, encapsulating contextual information that aligns with the user's intent. The generation of the segment may involve identifying bounding boxes, extracting visual features, and applying image preprocessing techniques such as resizing or normalization to prepare the segment for search-based analysis.

The system may then process the generated image segment using a search engine. This search engine may be either an internal model trained to interpret visual inputs or an external search platform capable of receiving image-based queries. The engine compares the input segment against a vast index of data sources, leveraging image recognition, object detection, OCR (Optical Character Recognition), and semantic analysis to infer the most relevant information. This may be done with the objective of interpreting what is visually or contextually represented within the segment and retrieving resources that closely match or explain the content. For example, a segment containing foreign text may lead to translations or related cultural references, while a product image may return identification, pricing, or reviews.

From this process, the system may derive one or more search results that reflect various possibilities, interpretations, or resources associated with the image segment. These search results may include outputs that are structured or unstructured provided by the search engine. They may include web links, snippets of text, reference images, metadata, or similar content.

In an embodiment, the query response 304 may be generated based on the search results. The query response 304 may be a refined representation of search results. The query response 304 may distill the findings of the search results into a response tailored based on the nature of the user's inquiry and the format of the underlying interface. This could involve extracting the most relevant data from the search results, translating key pieces of information into the user's language, or summarizing multiple pieces of content into a concise output. For example, if a user taps on an icon representing a landmark, the query response might display the name of the landmark, a short description, and travel tips derived from deeper search results.

With continued reference to FIG. 3, the operations may include overlaying the query response 304 onto the modified display data 122. This may include integrating relevant query response 304 directly within the displayed content 102. The system may determine the optimal placement of query response 304 by analyzing the spatial characteristics of the modified display data 122.

In some cases, the system may adjust the presentation of the query response 304 based on the structure of the modified display data 122. This may include resizing text, adapting contrast levels, or applying semi-transparent overlays to maintain readability while preserving the underlying content. The system may also utilize animation effects, such as fading or sliding transitions, to introduce the query response smoothly, reducing abrupt disruptions to the user experience.

In an embodiment, a translation indicator 306 may appear on the screen during real-time translation. The translation indicator 306 may serve as a visual cue to inform users that real-time translation is actively occurring within the system. The translation indicator 306 may come in various forms, including an icon, a progress bar, a highlighted area surrounding the UI, or a subtle animation applied to the translated text.

For example, the translation indicator 306 may appear as a small, persistent icon within the user interface, signaling that the system is processing and rendering translated content. Alternatively, it may take the form of a glowing or color-shifting border around the modified display data 122.

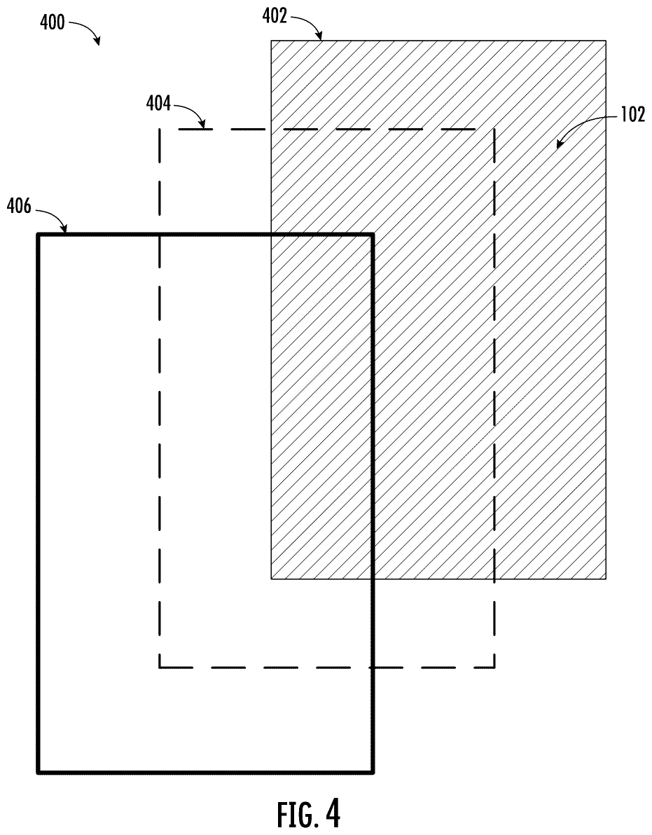

Referring now to FIG. 4, an exemplary diagram of layers of an exemplary user interface in accordance with exemplary embodiments of the present disclosure. FIG. 4 depicts a plurality of distinct layers, each serving a specific function in facilitating real-time translation. These layers may include but are not limited to a first layer 402, a second layer 404, a third layer 406, up to and including an Nth layer. Each of these layers may be configured to work in unison to facilitate user interaction with the underlying display content 102 while integrating system 100 functionalities such as real-time translation through inpainting and textual data modification.

The first layer 402 may be used to capture touch events and respond to user interactions as if the second and third layers do not exist. This layer functions as an invisible overlay that ensures the user's touch inputs are registered accurately without interference from additional UI elements. By directly capturing gestures, taps, and other interactions, the first layer 402 preserves the original touch-based functionality of the device while allowing modifications or enhancements to occur in the background.

The second layer 404 may operate as a full-screen window manager that intercepts and redirects all touch events. Unlike the first layer, which merely captures inputs, the second layer 404 may serve as a bridge between user interactions and system 100. The second layer 404 may process touch events and relay to the appropriate UI components, allowing the system to interact intelligently with the display content 102. Additionally, the second layer 404 may facilitate real-time translation by dynamically modifying the UI elements beneath it, ensuring that translated content is seamlessly integrated without disrupting the native display.

The third layer 406 may be responsible for visual feedback and includes elements such as the translation indicator 306. This layer may overlay the interface to provide users with status updates regarding real-time translation. The translation indicator 306 within the third layer 406 may appear as an icon, highlight, or animation, subtly informing users that translations are in progress. Since this layer is designed for visual cues rather than interaction handling, it may not interfere with user inputs but instead enhances the UI by providing contextual awareness of background processes.

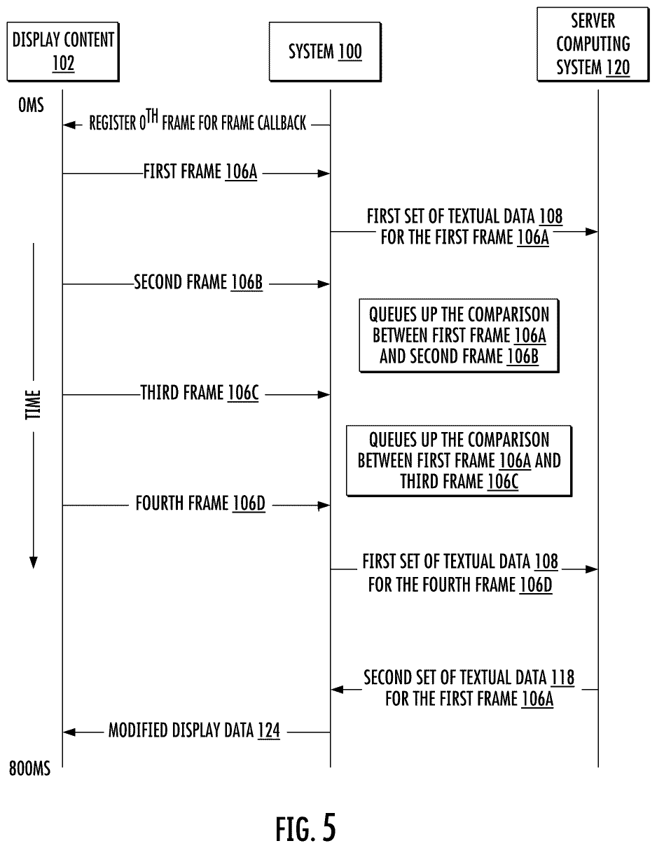

Referring now to FIG. 5, a diagram of an exemplary process for generating the second set of textual data. The process of generating the second set of textual data 118 may include the registration of the zeroth frame 202 for callback. This preliminary operation may be done to establish a baseline representation of the display content 102. The zeroth frame 202 may be captured, analyzed, and stored with its associated metadata, including resolution, aspect ratio, and structural composition. Once this preliminary operation is completed, the system may be configured to sequentially receive and process the first frame 106A, the second frame 106B, the third frame 106C, and the fourth frame 106D.

As system 100 receives the first frame 106A, it may extract the first set of textual data 108 embedded within the frame. This extracted text may be transmitted to a server computing system 120, where it undergoes translation into a second language. While this translation request is being processed, system 100 continues receiving subsequent frames. When the second frame 106B is received, system 100 may queue up a comparison between the first frame 106A and the second frame 106B to determine consistency in static regions. Similarly, upon receiving the third frame 106C, system 100 may queue up another comparison between the first frame 106A and the third frame 106C.

Meanwhile, system 100 may instruct the server computing system 120 to process the translation request, converting the first set of textual data 108 into the second set of textual data 118. The server computing system 120 may be instructed to transmit the second set of textual data 118 back to system 100. At this stage, system 100 utilizes the results of the frame comparisons to modify the display data 122 accordingly. System 100 may be configured to determine the appropriate placement of the translated text and integrate the translated text within the existing display content 102.

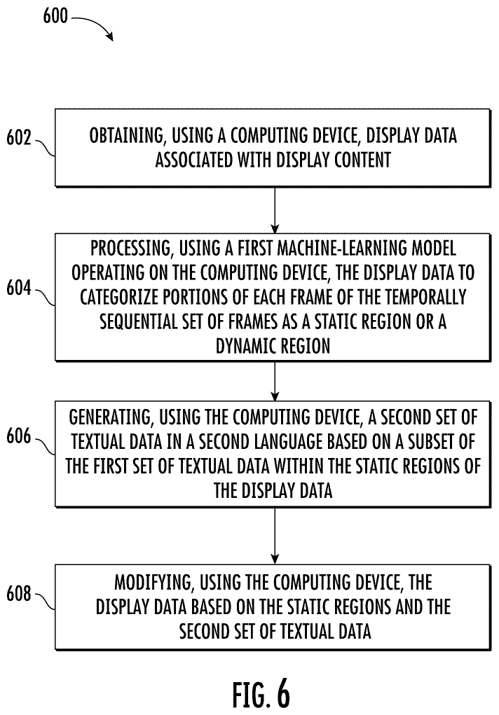

Referring now to FIG. 6, a flow diagram of an exemplary method for real-time text translation through inpainting and textual data modification in accordance with exemplary embodiments of the present disclosure.

At operation 602, the method includes obtaining, using a computing device, display data associated with display content, the display data includes: a temporally sequential set of frames; and a first set of textual data in a first language.

At operation 604, the method includes processing, using a first machine-learning model operating on the computing device, the display data to categorize portions of each frame of the temporally sequential set of frames as static regions or dynamic regions, the static regions includes display content that has shifted position across one or more frames within the temporally sequential set of frames while retaining its original content.

The method may include processing the display data using a computing device to generate an image patch grid associated with the temporally sequential set of frames. This operation may involve dividing the display content into smaller, structured segments or cells, which enables the system to analyze and track the content at a granular level. The image patch grid helps in the efficient identification and modification of various content regions within each frame.

Additionally, the system may use a first machine-learning model to process the temporally sequential set of frames. The first machine-learning model may be configured to identify two or more distinct subsets of cells: the first subset corresponds to static regions, which remain unchanged over time, and the second subset corresponds to dynamic regions, which change across frames.

In an additional embodiment, categorizing portions of each frame as static regions may include detecting positional changes of the first set of textual data across multiple frames. Using the first machine-learning model, the system may map the first set of textual data from its initial position in the first frame to its new position in subsequent frames. Despite the positional change, the data may be categorized as part of the static region because its content remains unchanged.

At operation 606, the method includes generating, using the computing device, a second set of textual data in a second language based on a subset of the first set of textual data within the static regions of the display data.

In an embodiment, generating the second set of textual data may include transmitting the first set of textual data to a server computing system. The system may instruct the server computing system to generate the second set of textual data based on the first set of textual data. Once the server computing system has processed the translation, it may be instructed to transmit the second set of textual data back to the computing device, where it can be applied to the display content.

In some cases, the temporally sequential set of frames may include at least a first and a second frame and comparing the static regions of each frame involves a comparison between the static regions of the first frame and the static regions of the second frame. This comparison may be used to track elements that remain consistent across frames, ensuring that modifications to the display data, such as text translation, are applied to only the static regions of the display data.

The comparison of the static regions between frames further involves mapping the static regions of the first frame to the static regions of the second frame. By mapping these regions, the system can preserve the integrity of the static content, even when user interactions or frame transitions cause slight positional shifts.

At operation 608, the method includes modifying, using the computing device, the display data based on the static regions and the second set of textual data by: inpainting portions of the display content including the first set of textual data; and rendering the second set of textual data in the portions that were inpainted.

In an embodiment, the method includes receiving a user inquiry associated with one or more frames within the temporally sequential set of frames. Based on this inquiry, the system may be configured to generate a query response in the second language and overlay it on top of the modified display data.

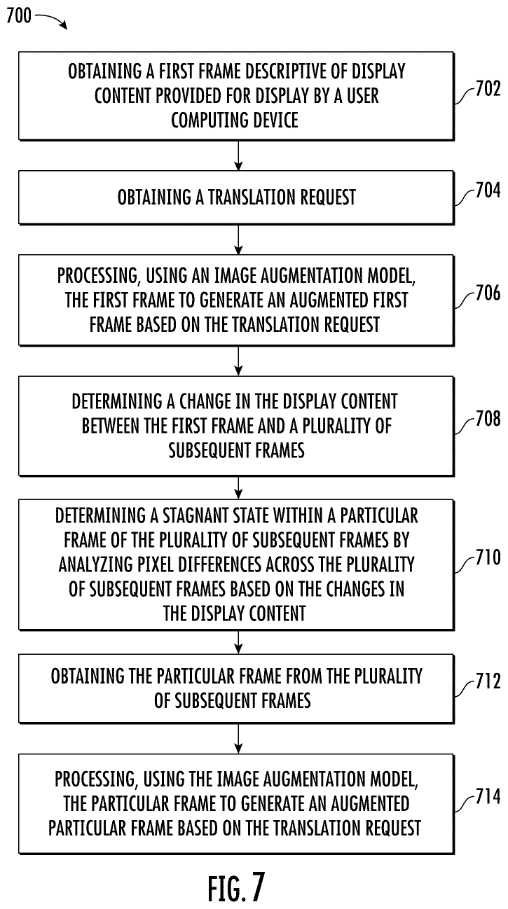

Referring now to FIG. 7, a flow diagram of an exemplary method for real-time text translation through inpainting and textual data modification in accordance with exemplary embodiments of the present disclosure.

At operation 702, the method includes obtaining a first frame descriptive of display content provided for display by a user computing device.

At operation 704, the method includes obtaining a translation request.

At operation 706, the method includes processing, using an image augmentation model, the first frame to generate an augmented first frame based on the translation request. Processing the first frame may include identifying a first set of textual data within the first frame. Processing the first frame may also include processing the first set of textual data within the first frame to generate a second set of textual data in a language that differs from the first set of textual data. The augmented first frame may be generated by replacing the first set of textual data with the second set of textual data.

At operation 708, the method includes determining a navigation event has occurred based on a change in the display content between the first frame and a plurality of subsequent frames.

At operation 710, the method includes determining the navigation event has ended based on determining a stagnant state has been reached within a particular frame of the plurality of subsequent frames by analyzing pixel differences across the plurality of subsequent frames based on the change in the display content;

At operation 712, the method includes obtaining the particular frame from the plurality of subsequent frames when the particular frame occurs after the navigation event ended;

At operation 714, the method includes processing, using the image augmentation model, the particular frame to generate an augmented particular frame based on the translation request. Generating the augmented particular frame may include identifying a third set of textual data within the particular frame. Generating the augmented particular frame may also include processing the third set of textual data within the particular frame to generate a fourth set of textual data in a language that differs from the third set of textual data, the second set of textual data and the fourth set of textual data are in a same language.

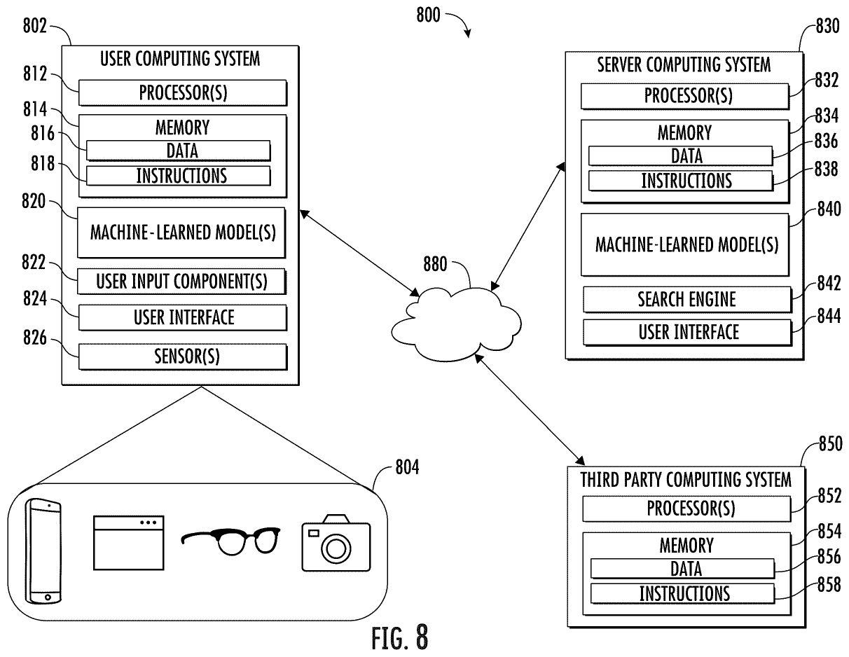

FIG. 8 depicts a block diagram of an example computing system 800 that performs real-time text translation through inpainting and textual data modification according to example embodiments of the present disclosure. The system 800 includes a user computing system 802, a server computing system 830, and/or a third-party computing system 850 that are communicatively coupled over a network 880.

The user computing system 802 can include any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing system 802 includes one or more processors 812 and a memory 814. The one or more processors 812 can be any suitable processing device (e.g., a processor core, a microprocessor, an ASIC, an FPGA, a controller, a microcontroller, etc.) and can be one processor or a plurality of processors that are operatively connected. The memory 814 can include one or more non-transitory computer-readable storage mediums, such as RAM, ROM, EEPROM, EPROM, flash memory devices, magnetic disks, etc., and combinations thereof. The memory 814 can store data 816 and instructions 818 which are executed by the processor 812 to cause the user computing system 802 to perform operations.

In some implementations, the user computing system 802 can store or include one or more machine-learned models 820. For example, the machine-learned models 820 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks.

In some implementations, the one or more machine-learned models 820 can be received from the server computing system 830 over network 880, stored in the user computing device memory 814, and then used or otherwise implemented by the one or more processors 812. In some implementations, the user computing system 802 can implement multiple parallel instances of a single machine-learned model 820 (e.g., to perform parallel machine-learned model processing across multiple instances of input data and/or detected features).

More particularly, the one or more machine-learned models 820 may include one or more detection models, one or more classification models, one or more segmentation models, one or more augmentation models, one or more generative models, one or more natural language processing models, one or more optical character recognition models, and/or one or more other machine-learned models. The one or more machine-learned models 820 can include one or more transformer models. The one or more machine-learned models 820 may include one or more neural radiance field models, one or more diffusion models, and/or one or more autoregressive language models.

The one or more machine-learned models 820 may be utilized to detect one or more object features. The detected object features may be classified and/or embedded. The classification and/or the embedding may then be utilized to perform a search to determine one or more search results. Alternatively and/or additionally, the one or more detected features may be utilized to determine an indicator (e.g., a user interface element that indicates a detected feature) is to be provided to indicate a feature has been detected. The user may then select the indicator to cause a feature classification, embedding, and/or search to be performed. In some implementations, the classification, the embedding, and/or the searching can be performed before the indicator is selected.

In some implementations, the one or more machine-learned models 820 can process image data, text data, audio data, and/or latent encoding data to generate output data that can include image data, text data, audio data, and/or latent encoding data. The one or more machine-learned models 820 may perform optical character recognition, natural language processing, image classification, object classification, text classification, audio classification, context determination, action prediction, image correction, image augmentation, text augmentation, sentiment analysis, object detection, error detection, inpainting, video stabilization, audio correction, audio augmentation, and/or data segmentation (e.g., mask based segmentation).

Machine-learned model(s) can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree-based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) can include a single or multiple instances of the same model configured to operate on data from input(s). Machine-learned model(s) can include an ensemble of different models that can cooperatively interact to process data from input(s). For example, machine-learned model(s) can employ a mixture-of-experts structure. See, e.g., Zhou et al., Mixture-of-Experts with Expert Choice Routing, ARXIV:2202.07368v2 (Oct. 14, 2022).

Input(s) can generally include or otherwise represent various types of data. Input(s) can include one type or many different types of data. Output(s) can be data of the same type(s) or of different types of data as compared to input(s). Output(s) can include one type or many different types of data.

Example data types for input(s) or output(s) include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs or outputs, example combinations of data types include image data and audio data, image data and natural language data, natural language data and software code data, image data and biometric data, sensor data and medical data, etc. It is to be understood that any combination of data types in an input or an output can be present.

An example input can include one or multiple data types, such as the example data types noted above. An example output can include one or multiple data types, such as the example data types noted above. The data type(s) of input can be the same as or different from the data type(s) of output. It is to be understood that the example data types noted above are provided for illustrative purposes only. Data types contemplated within the scope of the present disclosure are not limited to those examples noted above.

Additionally or alternatively, one or more machine-learned models 840 can be included in or otherwise stored and implemented by the server computing system 830 that communicates with the user computing system 802 according to a client-server relationship. For example, the machine-learned models 840 can be implemented by the server computing system 830 as a portion of a web service (e.g., a viewfinder service, a visual search service, an image processing service, an ambient computing service, and/or an overlay application service). Thus, one or more models 820 can be stored and implemented at the user computing system 802 and/or one or more models 840 can be stored and implemented at the server computing system 830.

The user computing system 802 can also include one or more user input components 822 that receives user input. For example, the user input component 822 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

In some implementations, the user computing system 802 can store and/or provide one or more user interfaces 824, which may be associated with one or more applications. The one or more user interfaces 824 can be configured to receive inputs and/or provide data for display (e.g., image data, text data, audio data, one or more user interface elements, an augmented-reality experience, a virtual reality experience, and/or other data for display. The user interfaces 824 may be associated with one or more other computing systems (e.g., server computing system 830 and/or third-party computing system 850). The user interfaces 824 can include a viewfinder interface, a search interface, a generative model interface, a social media interface, and/or a media content gallery interface.

The user computing system 802 may include and/or receive data from one or more sensors 826. The one or more sensors 826 may be housed in a housing component that houses the one or more processors 812, the memory 814, and/or one or more hardware components, which may store, and/or cause to perform, one or more software packets. The one or more sensors 826 can include one or more image sensors (e.g., a camera), one or more lidar sensors, one or more audio sensors (e.g., a microphone), one or more inertial sensors (e.g., inertial measurement unit), one or more biological sensors (e.g., a heart rate sensor, a pulse sensor, a retinal sensor, and/or a fingerprint sensor), one or more infrared sensors, one or more location sensors (e.g., GPS), one or more touch sensors (e.g., a conductive touch sensor and/or a mechanical touch sensor), and/or one or more other sensors. The one or more sensors can be utilized to obtain data associated with a user's environment (e.g., an image of a user's environment, a recording of the environment, and/or the location of the user).

The user computing system 802 may include, and/or be part of, a user computing device 804. The user computing device 804 may include a mobile computing device (e.g., a smartphone or tablet), a desktop computer, a laptop computer, a smart wearable, and/or a smart appliance. Additionally and/or alternatively, the user computing system may obtain from, and/or generate data with, the one or more user computing devices 804. For example, a camera of a smartphone may be utilized to capture image data descriptive of the environment, and/or an overlay application of the user computing device 804 can be utilized to track and/or process the data being provided to the user. Similarly, one or more sensors associated with a smart wearable may be utilized to obtain data about a user and/or about a user's environment (e.g., image data can be obtained with a camera housed in a user's smart glasses). Additionally and/or alternatively, the data may be obtained and uploaded from other user devices that may be specialized for data obtainment or generation.

The server computing system 830 includes one or more processors 832 and a memory 834. The one or more processors 832 can be any suitable processing device (e.g., a processor core, a microprocessor, an ASIC, a FPGA, a controller, a microcontroller, etc.) and can be one processor or a plurality of processors that are operatively connected. The memory 834 can include one or more non-transitory computer-readable storage mediums, such as RAM, ROM, EEPROM, EPROM, flash memory devices, magnetic disks, etc., and combinations thereof. The memory 834 can store data 836 and instructions 838 which are executed by the processor 832 to cause the server computing system 830 to perform operations.

In some implementations, the server computing system 830 includes or is otherwise implemented by one or more server computing devices. In instances in which the server computing system 830 includes plural server computing devices, such server computing devices can operate according to sequential computing architectures, parallel computing architectures, or some combination thereof.

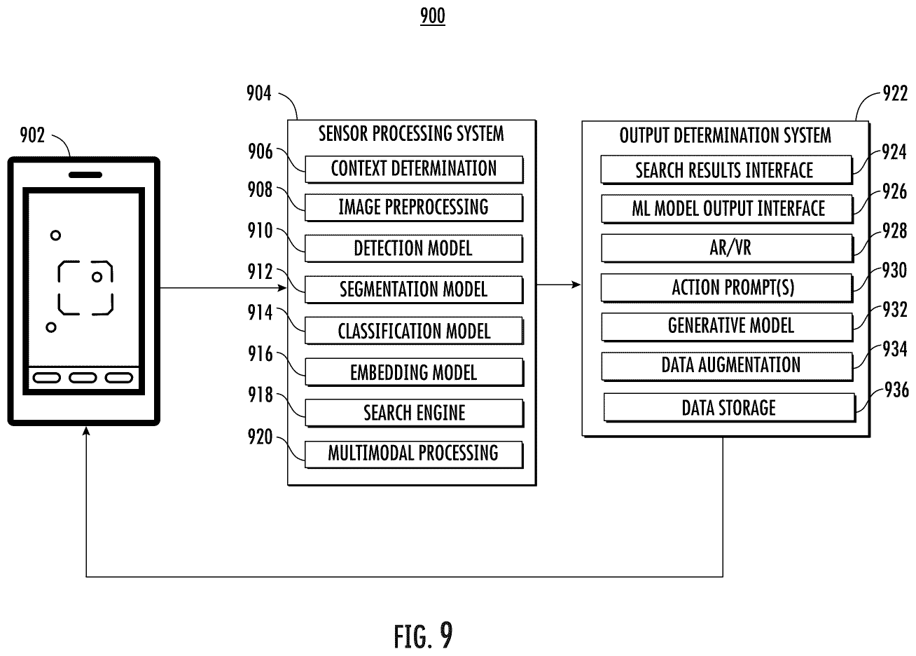

As described above, the server computing system 830 can store or otherwise include one or more machine-learned models 840. For example, the models 840 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 840 are discussed with reference to FIG. 9.

Additionally and/or alternatively, the server computing system 830 can include and/or be communicatively connected with a search engine 842 that may be utilized to crawl one or more databases (and/or resources). The search engine 842 can process data from the user computing system 802, the server computing system 830, and/or the third party computing system 850 to determine one or more search results associated with the input data. The search engine 842 may perform term based search, label based search, Boolean based searches, image search, embedding based search (e.g., nearest neighbor search), multimodal search, and/or one or more other search techniques.

The server computing system 830 may store and/or provide one or more user interfaces 844 for obtaining input data and/or providing output data to one or more users. The one or more user interfaces 844 can include one or more user interface elements, which may include input fields, navigation tools, content chips, selectable tiles, widgets, data display carousels, dynamic animation, informational pop-ups, image augmentations, text-to-speech, speech-to-text, augmented-reality, virtual-reality, feedback loops, and/or other interface elements.

The user computing system 802 and/or the server computing system 830 can train the models 820 and/or 840 via interaction with the third party computing system 850 that is communicatively coupled over the network 880. The third party computing system 850 can be separate from the server computing system 830 or can be a portion of the server computing system 830. Alternatively and/or additionally, the third party computing system 850 may be associated with one or more web resources, one or more web platforms, one or more other users, and/or one or more contexts.

An example machine-learned model can include a generative model (e.g., a large language model, a foundation model, a vision language model, an image generation model, a text-to-image model, an audio generation model, and/or other generative models).

Training and/or tuning the machine-learned model can include obtaining a training instance. A set of training data can include a plurality of training instances divided between multiple datasets (e.g., a training dataset, a validation dataset, or testing dataset). A training instance can be labeled or unlabeled. The runtime inferences can form training instances when a model is trained using an evaluation of the model's performance on that runtime instance (e.g., online training/learning). Example data types for the training instance and various tasks associated therewith are described throughout the present disclosure.

The third party computing system 850 can include one or more processors 852 and a memory 854. The one or more processors 852 can be any suitable processing device (e.g., a processor core, a microprocessor, an ASIC, a FPGA, a controller, a microcontroller, etc.) and can be one processor or a plurality of processors that are operatively connected. The memory 854 can include one or more non-transitory computer-readable storage mediums, such as RAM, ROM, EEPROM, EPROM, flash memory devices, magnetic disks, etc., and combinations thereof. The memory 854 can store data 856 and instructions 858 which are executed by the processor 852 to cause the third party computing system 850 to perform operations. In some implementations, the third party computing system 850 includes or is otherwise implemented by one or more server computing devices.

The network 880 can be any type of communications network, such as a local area network (e.g., intranet), wide area network (e.g., Internet), or some combination thereof and can include any number of wired or wireless links. In general, communication over the network 880 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, the task can be a generative task, and the one or more machine-learned models (e.g., 820 and/or 840) can be configured to output content generated in view of one or more inputs. For instance, the inputs can be or otherwise represent data of one or more modalities that encodes context for generating additional content.

In some implementations, the task can be a text completion task. The machine-learned models can be configured to process the inputs that represent textual data and to generate the outputs that represent additional textual data that completes a textual sequence that includes the inputs. For instance, the machine-learned models can be configured to generate the outputs to complete a sentence, paragraph, or portion of text that follows from a portion of text represented by inputs.

In some implementations, the task can be an instruction following task. The machine-learned models can be configured to process the inputs that represent instructions to perform a function and to generate the outputs that advance a goal of satisfying the instruction function (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the instructions (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the instructions (e.g., natural language responses, programming language responses, machine language responses, etc.). One or more outputs can be iteratively or recursively generated to sequentially process and accomplish steps toward accomplishing the requested functionality. For instance, an initial output can be executed by an external system or be processed by the machine-learned models to complete an initial step of performing a function. Multiple steps can be performed, with a final output being obtained that is responsive to the initial instructions.

In some implementations, the task can be a question answering task. The machine-learned models can be configured to process the inputs that represent a question to answer and to generate the outputs that advance a goal of returning an answer to the question (e.g., at least a step of a multi-step procedure to perform the function). The outputs can represent data of the same or of a different modality as the inputs. For instance, the inputs can represent textual data (e.g., natural language instructions for a task to be performed) and the machine-learned models can process the inputs to generate the outputs that represent textual data responsive to the question (e.g., natural language responses, programming language responses, machine language responses, etc.). The inputs can represent image data (e.g., image-based instructions for a task to be performed, optionally accompanied by textual instructions) and the machine-learned models can process the inputs to generate the outputs that represent textual data responsive to the question (e.g., natural language responses, programming language responses, machine language responses, etc.). One or more outputs can be iteratively or recursively generated to sequentially process and accomplish steps toward answering the question. For instance, an initial output can be executed by an external system or be processed by the machine-learned models to complete an initial step of obtaining an answer to the question (e.g., querying a database, performing a computation, executing a script, etc.). Multiple steps can be performed, with a final output being obtained that is responsive to the question.

In some implementations, the task can be an image generation task. The machine-learned models can be configured to process the inputs that represent context regarding a desired portion of image content. The context can include text data, image data, audio data, etc. Machine-learned models can be configured to generate the outputs that represent image data that depicts imagery related to the context. For instance, the machine-learned models can be configured to generate pixel data of an image. Values for channels associated with the pixels in the pixel data can be selected based on the context (e.g., based on a probability determined based on the context).

In some implementations, the task can be an audio generation task. Machine-learned models can be configured to process the inputs that represent context regarding a desired portion of audio content. The context can include text data, image data, audio data, etc. The machine-learned models can be configured to generate the outputs that represent audio data related to the context. For instance, the machine-learned models can be configured to generate waveform data in the form of an image (e.g., a spectrogram). Values for channels associated with pixels of the image can be selected based on the context. The machine-learned models can be configured to generate waveform data in the form of a sequence of discrete samples of a continuous waveform. Values of the sequence can be selected based on the context (e.g., based on a probability determined based on the context).

In some implementations, the task can be a data generation task. Machine-learned models can be configured to process the inputs that represent context regarding a desired portion of data (e.g., data from various data domains, such as sensor data, image data, multimodal data, statistical data, etc.). The desired data can be, for instance, synthetic data for training other machine-learned models. The context can include arbitrary data types. The machine-learned models can be configured to generate the outputs that represent data that aligns with the desired data. For instance, the machine-learned models can be configured to generate data values for populating a dataset. Values for the data objects can be selected based on the context (e.g., based on a probability determined based on the context).

The user computing system may include a number of applications (e.g., applications 1 through N). Each application may include its own respective machine learning library and machine-learned model(s). For example, each application can include a machine-learned model. Example applications include a text messaging application, an email application, a dictation application, a virtual keyboard application, a browser application, etc.

Each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

The user computing system 802 can include a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing system 800.

The central intelligence layer can communicate with a central device data layer. The central device data layer can be a centralized repository of data for the computing system 800. The central device data layer may communicate with a number of other components of the computing device, such as, for example, one or more sensors, a context manager, a device state component, and/or additional components. In some implementations, the central device data layer can communicate with each device component using an API (e.g., a private API).

FIG. 9 depicts a block diagram of an example computing system 900 that performs real-time text translation through inpainting and textual data modification according to example embodiments of the present disclosure. In particular, the example computing system 900 can include one or more computing devices 902 that can be utilized to obtain, and/or generate, one or more datasets that can be processed by a sensor processing system 904 and/or an output determination system 922 to feedback to a user that can provide information on features in the one or more obtained datasets. The one or more datasets can include image data, text data, audio data, multimodal data, latent encoding data, etc. The one or more datasets may be obtained via one or more sensors associated with the one or more computing devices 902 (e.g., one or more sensors in the computing device 902). Additionally and/or alternatively, the one or more datasets can be stored data and/or retrieved data (e.g., data retrieved from a web resource). For example, images, text, and/or other content items may be interacted with by a user. The interacted with content items can then be utilized to generate one or more determinations.

The one or more computing devices 902 can obtain, and/or generate, one or more datasets based on image capture, sensor tracking, data storage retrieval, content download (e.g., downloading an image or other content item via the internet from a web resource), and/or via one or more other techniques. The one or more datasets can be processed with a sensor processing system 904. The sensor processing system 904 may perform one or more processing techniques using one or more machine-learned models, one or more search engines, and/or one or more other processing techniques. The one or more processing techniques can be performed in any combination and/or individually. The one or more processing techniques can be performed in series and/or in parallel. In particular, the one or more datasets can be processed with a context determination block 906, which may determine a context associated with one or more content items. The context determination block 906 may identify and/or process metadata, user profile data (e.g., preferences, user search history, user browsing history, user purchase history, and/or user input data), previous interaction data, global trend data, location data, time data, and/or other data to determine a particular context associated with the user. The context can be associated with an event, a determined trend, a particular action, a particular type of data, a particular environment, and/or another context associated with the user and/or the retrieved or obtained data.

The sensor processing system 904 may include an image preprocessing block 908. The image preprocessing block 908 may be utilized to adjust one or more values of an obtained and/or received image to prepare the image to be processed by one or more machine-learned models and/or one or more search engines 918. The image preprocessing block 908 may resize the image, adjust saturation values, adjust resolution, strip and/or add metadata, and/or perform one or more other operations.

In some implementations, the sensor processing system 904 can include one or more machine-learned models, which may include a detection model 910, a segmentation model 912, a classification model 914, an embedding model 916, and/or one or more other machine-learned models. For example, the sensor processing system 904 may include one or more detection models 910 that can be utilized to detect particular features in the processed dataset. In particular, one or more images can be processed with the one or more detection models 910 to generate one or more bounding boxes associated with detected features in the one or more images.

Additionally and/or alternatively, one or more segmentation models 912 can be utilized to segment one or more portions of the dataset from the one or more datasets. For example, the one or more segmentation models 912 may utilize one or more segmentation masks (e.g., one or more segmentation masks manually generated and/or generated based on the one or more bounding boxes) to segment a portion of an image, a portion of an audio file, and/or a portion of text. The segmentation may include isolating one or more detected objects and/or removing one or more detected objects from an image.

The one or more classification models 914 can be utilized to process image data, text data, audio data, latent encoding data, multimodal data, and/or other data to generate one or more classifications. The one or more classification models 914 can include one or more image classification models, one or more object classification models, one or more text classification models, one or more audio classification models, and/or one or more other classification models. The one or more classification models 914 can process data to determine one or more classifications.

In some implementations, data may be processed with one or more embedding models 916 to generate one or more embeddings. For example, one or more images can be processed with the one or more embedding models 916 to generate one or more image embeddings in an embedding space. The one or more image embeddings may be associated with one or more image features of the one or more images. In some implementations, the one or more embedding models 916 may be configured to process multimodal data to generate multimodal embeddings. The one or more embeddings can be utilized for classification, search, and/or learning embedding space distributions.

The sensor processing system 904 may include one or more search engines 918 that can be utilized to perform one or more searches. The one or more search engines 918 may crawl one or more databases (e.g., one or more local databases, one or more global databases, one or more private databases, one or more public databases, one or more specialized databases, and/or one or more general databases) to determine one or more search results. The one or more search engines 918 may perform feature matching, text based search, embedding based search (e.g., k-nearest neighbor search), metadata based search, multimodal search, web resource search, image search, text search, and/or application search.

Additionally and/or alternatively, the sensor processing system 904 may include one or more multimodal processing blocks 920, which can be utilized to aid in the processing of multimodal data. The one or more multimodal processing blocks 920 may include generating a multimodal query and/or a multimodal embedding to be processed by one or more machine-learned models and/or one or more search engines 918.

The output(s) of the sensor processing system 904 can then be processed with an output determination system 922 to determine one or more outputs to provide to a user. The output determination system 922 may include heuristic based determinations, machine-learned model based determinations, user selection based determinations, and/or context based determinations.

The output determination system 922 may determine how and/or where to provide the one or more search results in a search results interface 924. Additionally and/or alternatively, the output determination system 922 may determine how and/or where to provide the one or more machine-learned model outputs in a machine-learned model output interface 926. In some implementations, the one or more search results and/or the one or more machine-learned model outputs may be provided for display via one or more user interface elements. The one or more user interface elements may be overlayed over displayed data. For example, one or more detection indicators may be overlaid over detected objects in a viewfinder. The one or more user interface elements may be selectable to perform one or more additional searches and/or one or more additional machine-learned model processes. In some implementations, the user interface elements may be provided as specialized user interface elements for specific applications and/or may be provided uniformly across different applications. The one or more user interface elements can include pop-up displays, interface overlays, interface tiles and/or chips, carousel interfaces, audio feedback, animations, interactive widgets, and/or other user interface elements.

Additionally and/or alternatively, data associated with the output(s) of the sensor processing system 904 may be utilized to generate and/or provide an augmented-reality experience and/or a virtual-reality experience 928. For example, the one or more obtained datasets may be processed to generate one or more augmented-reality rendering assets and/or one or more virtual-reality rendering assets, which can then be utilized to provide an augmented-reality experience and/or a virtual-reality experience 928 to a user. The augmented-reality experience may render information associated with an environment into the respective environment. Alternatively and/or additionally, objects related to the processed dataset(s) may be rendered into the user environment and/or a virtual environment. Rendering dataset generation may include training one or more neural radiance field models to learn a three-dimensional representation for one or more objects.

In some implementations, one or more action prompts 930 may be determined based on the output(s) of the sensor processing system 904. For example, a search prompt, a purchase prompt, a generate prompt, a reservation prompt, a call prompt, a redirect prompt, and/or one or more other prompts may be determined to be associated with the output(s) of the sensor processing system 904. The one or more action prompts 930 may then be provided to the user via one or more selectable user interface elements. In response to a selection of the one or more selectable user interface elements, a respective action of the respective action prompt may be performed (e.g., a search may be performed, a purchase application programming interface may be utilized, and/or another application may be opened).

In some implementations, the one or more datasets and/or the output(s) of the sensor processing system 904 may be processed with one or more generative models 932 to generate a model-generated content item that can then be provided to a user. The generation may be prompted based on a user selection and/or may be automatically performed (e.g., automatically performed based on one or more conditions, which may be associated with a threshold amount of search results not being identified).

The one or more generative models 932 can include language models (e.g., large language models and/or vision language models), image generation models (e.g., text-to-image generation models and/or image augmentation models), audio generation models, video generation models, graph generation models, and/or other data generation models (e.g., other content generation models). The one or more generative models 932 can include one or more transformer models, one or more convolutional neural networks, one or more recurrent neural networks, one or more feedforward neural networks, one or more generative adversarial networks, one or more self-attention models, one or more embedding models, one or more encoders, one or more decoders, and/or one or more other models. In some implementations, the one or more generative models 932 can include one or more autoregressive models (e.g., a machine-learned model trained to generate predictive values based on previous behavior data) and/or one or more diffusion models (e.g., a machine-learned model trained to generate predicted data based on generating and processing distribution data associated with the input data).

The one or more generative models 932 can be trained to process input data and generate model-generated content items, which may include a plurality of predicted words, pixels, signals, and/or other data. The model-generated content items may include novel content items that are not the same as any pre-existing work. The one or more generative models 90 can leverage learned representations, sequences, and/or probability distributions to generate the content items, which may include phrases, storylines, settings, objects, characters, beats, lyrics, and/or other aspects that are not included in pre-existing content items.

The one or more generative models 932 may include a vision language model.

The vision language model can be trained, tuned, and/or configured to process image data and/or text data to generate a natural language output. The vision language model may leverage a pre-trained large language model (e.g., a large autoregressive language model) with one or more encoders (e.g., one or more image encoders and/or one or more text encoders) to provide detailed natural language outputs that emulate natural language composed by a human.

The vision language model may be utilized for zero-shot image classification, few shot image classification, image captioning, multimodal query distillation, multimodal question and answering, and/or may be tuned and/or trained for a plurality of different tasks. The vision language model can perform visual question answering, image caption generation, feature detection (e.g., content monitoring (e.g., for inappropriate content)), object detection, scene recognition, and/or other tasks.

The vision language model may leverage a pre-trained language model that may then be tuned for multimodality. Training and/or tuning of the vision language model can include image-text matching, masked-language modeling, multimodal fusing with cross attention, contrastive learning, prefix language model training, and/or other training techniques. For example, the vision language model may be trained to process an image to generate predicted text that is similar to ground truth text data (e.g., a ground truth caption for the image). In some implementations, the vision language model may be trained to replace masked tokens of a natural language template with textual tokens descriptive of features depicted in an input image. Alternatively and/or additionally, the training, tuning, and/or model inference may include multi-layer concatenation of visual and textual embedding features. In some implementations, the vision language model may be trained and/or tuned via jointly learning image embedding and text embedding generation, which may include training and/or tuning a system to map embeddings to a joint feature embedding space that maps text features and image features into a shared embedding space. The joint training may include image-text pair parallel embedding and/or may include triplet training. In some implementations, the images may be utilized and/or processed as prefixes to the language model.

The one or more generative models 932 may be stored on-device and/or may be stored on a server computing system. In some implementations, the one or more generative models 932 can perform on-device processing to determine suggested searches, suggested actions, and/or suggested prompts. The one or more generative models 932 may include one or more compact vision language models that may include less parameters than a vision language model stored and operated by the server computing system. The compact vision language model may be trained via distillation training. In some implementations, the visional language model may process the display data to generate suggestions. The display data can include a single image descriptive of a screenshot and/or may include image data, metadata, and/or other data descriptive of a period of time preceding the current displayed content (e.g., the applications, images, videos, messages, and/or other content viewed within the past 30 seconds). The user computing device may generate and store a rolling buffer window (e.g., 30 seconds) of data descriptive of content displayed during the buffer. Once the time has elapsed, the data may be deleted. The rolling buffer window data may be utilized to determine a context, which can be leveraged for query, content, action, and/or prompt suggestion.

In some implementations, the generative models 932 can include machine-learned sequence processing models. An example system can pass inputs to sequence processing models. Sequence processing models can include one or more machine-learned components. Sequence processing models can process the data from inputs to obtain an input sequence. Input sequence can include one or more input elements obtained from inputs. The sequence processing model can process the input sequence using prediction layers to generate an output sequence. The output sequence can include one or more output elements generated based on input sequence. The system can generate outputs based on output sequence.

The output determination system 922 may process the one or more datasets and/or the output(s) of the sensor processing system 904 with a data augmentation block 934 to generate augmented data. For example, one or more images can be processed with the data augmentation block 934 to generate one or more augmented images. The data augmentation can include data correction, data cropping, the removal of one or more features, the addition of one or more features, a resolution adjustment, a lighting adjustment, a saturation adjustment, and/or other augmentation.

In some implementations, the one or more datasets and/or the output(s) of the sensor processing system 904 may be stored based on a data storage block 936 determination.

The output(s) of the output determination system 922 can then be provided to a user via one or more output components of the user computing device 902. For example, one or more user interface elements associated with the one or more outputs can be provided for display via a visual display of the user computing device 902.

The processes may be performed iteratively and/or continuously. One or more user inputs to the provided user interface elements may condition and/or affect successive processing loops.

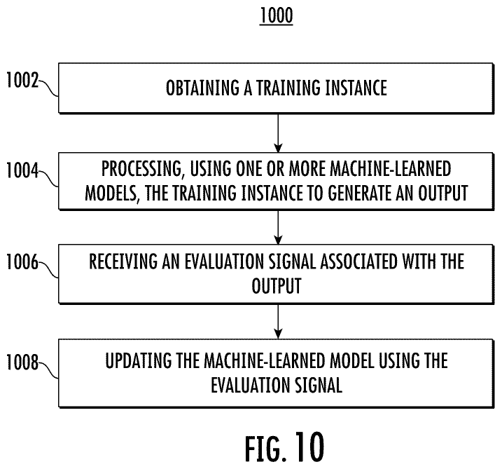

FIG. 10 depicts a flowchart of a method 900 for training one or more machine-learned models according to aspects of the present disclosure. For instance, an example machine-learned model can include a first machine-learning model 116, a second machine-learning model 124, or any other model or algorithm mentioned throughout the disclosure.

One or more portion(s) of example method 900 can be implemented by a computing system that includes one or more computing devices such as, for example, computing systems described with reference to the other figures. Each respective portion of example method 900 can be performed by any (or any combination) of one or more computing devices. Moreover, one or more portion(s) of example method 1000 can be implemented on the hardware components of the device(s) described herein, for example, to train one or more systems or models. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 10 is described with reference to elements/terms described with respect to other systems and figures for exemplary illustrated purposes and is not meant to be limiting. One or more portions of example method 1000 can be performed additionally, or alternatively, by other systems.

At 1002, example method 1000 can include obtaining a training instance. A set of training data can include a plurality of training instances divided between multiple datasets (e.g., a training dataset, a validation dataset, or testing dataset). A training instance can be labeled or unlabeled. Although referred to in example method 1000 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 1004, example method 1000 can include processing, using one or more machine-learned models, the training instance to generate an output. The output can be directly obtained from the one or more machine-learned models or can be a downstream result of a chain of processing operations that includes an output of the one or more machine-learned models.

At 1006, example method 1000 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 1008, example method 1000 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 1000 can include implementing a number of generalization techniques (e.g., weight decays, dropouts, etc.) to improve the generalization capability of the models being trained.

In some implementations, example method 1000 can be implemented for training a machine-learned model from an initialized state to a fully trained state (e.g., when the model exhibits a desired performance profile, such as based on accuracy, precision, recall, etc.).

In some implementations, example method 1000 can be implemented for particular stages of a training procedure. For instance, in some implementations, example method 1000 can be implemented for pre-training a machine-learned model. Pre-training can include, for instance, large-scale training over potentially noisy data to achieve a broad base of performance levels across a variety of tasks/data types. In some implementations, example method 1000 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). An example fine-tuning approach includes reinforcement learning. Reinforcement learning can be based on user feedback on model performance during use.

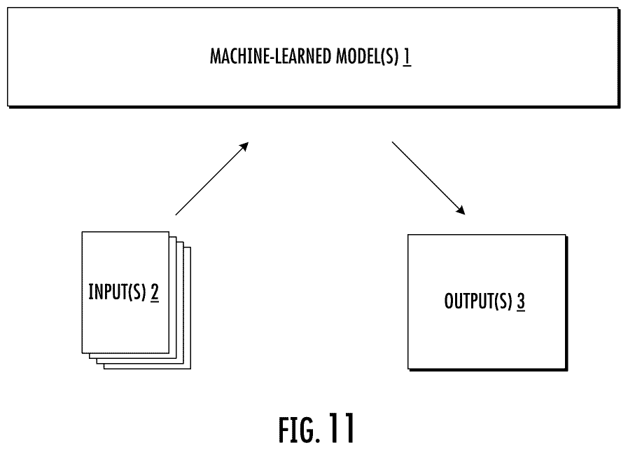

FIG. 11 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree-based models, support vector machines, hidden Markov models, Bayesian networks, linear regression models, k-means clustering models, etc.

Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention. For example, some example machine-learned models can include multi-headed self-attention models.

Machine-learned model(s) 1 can include a single or multiple instances of the same model configured to operate on data from input(s) 2. Machine-learned model(s) 1 can include an ensemble of different models that can cooperatively interact to process data from input(s) 2. For example, machine-learned model(s) 1 can employ a mixture-of-experts structure. See, e.g., Zhou et al., Mixture-of-Experts with Expert Choice Routing, ARXIV: 2202.09368v2 (Oct. 14, 2022).

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

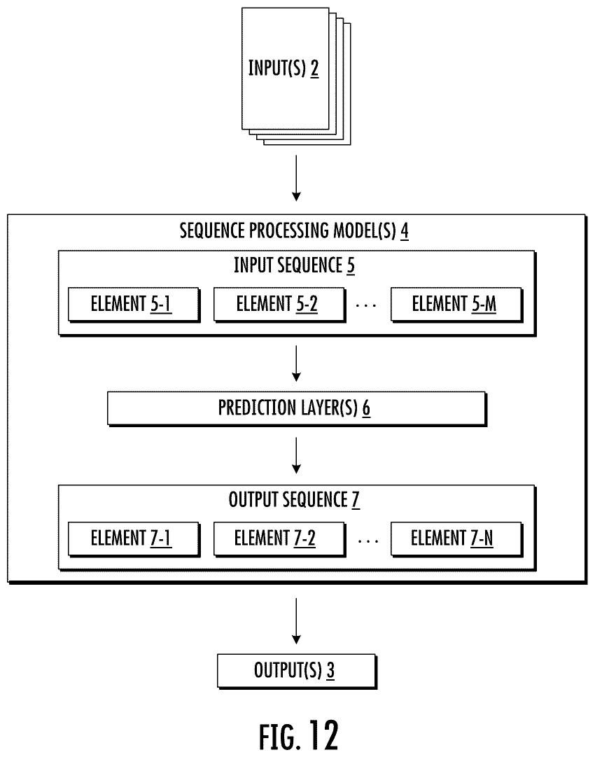

FIG. 12 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2,. 5-M, etc. obtained from input(s) 2. Sequence processing model 4 can process input sequence 5 using prediction layer(s) 6 to generate an output sequence 7. Output sequence 7 can include one or more output elements 7-1, 7-2,. 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models in the text domain are referred to as “Large Language Models,” or LLMs. See, e.g., PaLM 2 Technical Report, GOOGLE, https://ai.google/static/documents/palm2techreport.pdf (n.d.). Other example sequence processing models can operate in other domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV: 2301.11325v1 (Jan. 26, 2023), biochemical domains, see, e.g., Jumper et al., Highly accurate protein structure prediction with AlphaFold, 596 Nature 583 (Aug. 26, 2021), by way of example. Sequence processing model(s) 4 can process one or multiple types of data simultaneously. Sequence processing model(s) 4 can include relatively large models (e.g., more parameters, computationally expensive, etc.), relatively small models (e.g., fewer parameters, computationally lightweight, etc.), or both.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . , 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . , 5-M can represent tokens obtained using a tokenizer. For instance, a tokenizer can process a given portion of an input source and output a series of tokens (e.g., corresponding to input elements 5-1, 5-2, . . . , 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (October 31-Nov. 4, 2018), https://aclanthology.org/D 18-2012.pdf.Image-based input source(s) can be tokenized by extracting and serializing patches from an image.

In general, arbitrary data types can be serialized and processed into input sequence 5. It is to be understood that element(s) 5-1, 5-2, . . . , 5-M depicted in FIG. 12 can be the tokens or can be the embedded representations thereof.

Prediction layer(s) 6 can predict one or more output elements 7-1, 7-2, . . . , . . . , 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . , 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ______.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 4. See, e.g., Vaswani et al., Attention Is All You Need, ARXIV: 1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . , 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV: 2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perception that outputs a likely class value associated with an input image.

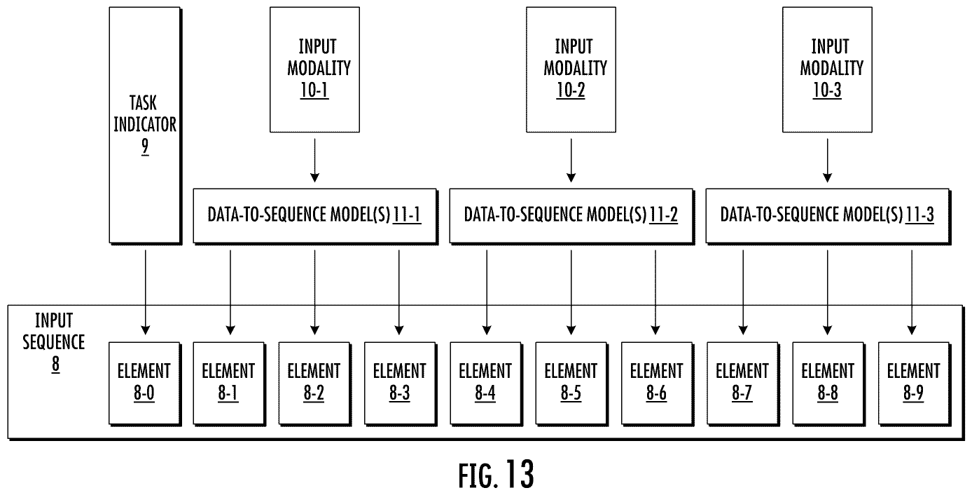

FIG. 13 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . , 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary datatype data-to-sequence model can subdivide an input of that arbitrary datatype and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

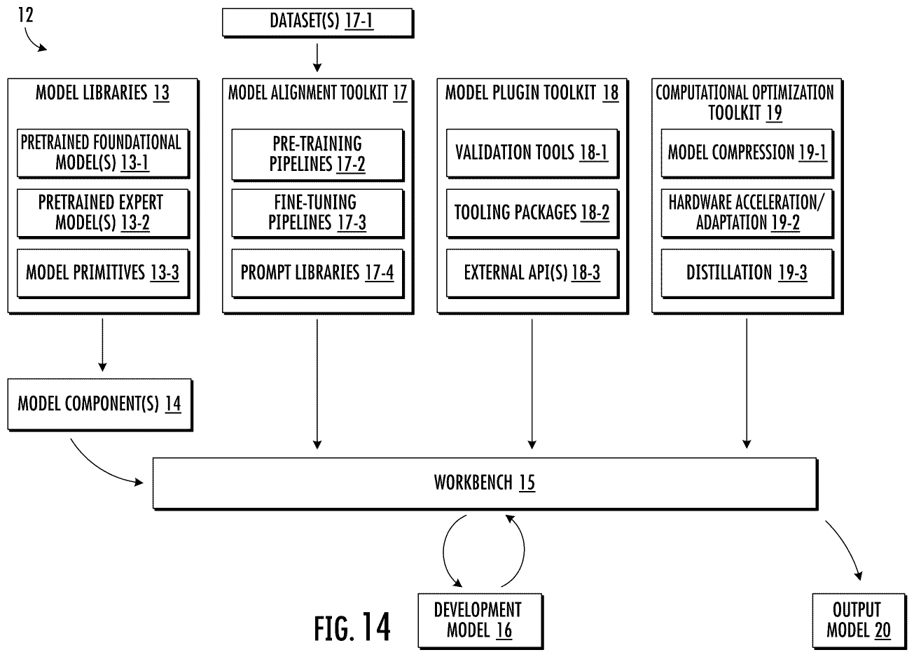

FIG. 14 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing the accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without examples in the inputs. For instance, zero-shot prompts can include inputs that lack examples. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 900 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

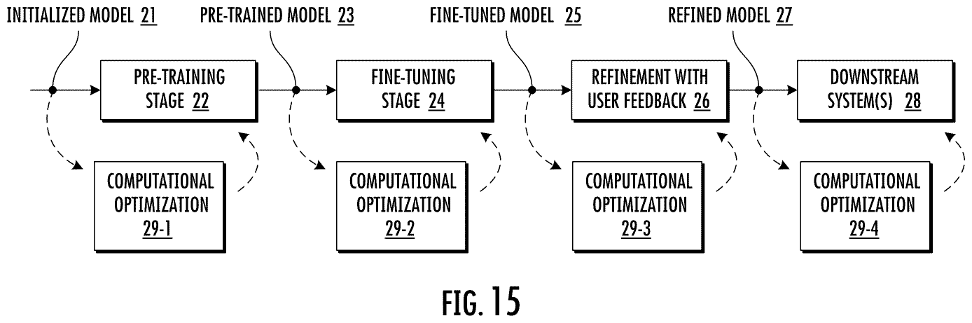

FIG. 15 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 14 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 14 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 29 can then be a new version of development model 16, which can persist as development model 16 or as a new development model. Fine-tuned model 29 can be the initial state if the development model 16 was already fine-tuned. Fine-tuned model 29 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1,. 29-4 can all be the same, all be different, or include at least some different optimization techniques.

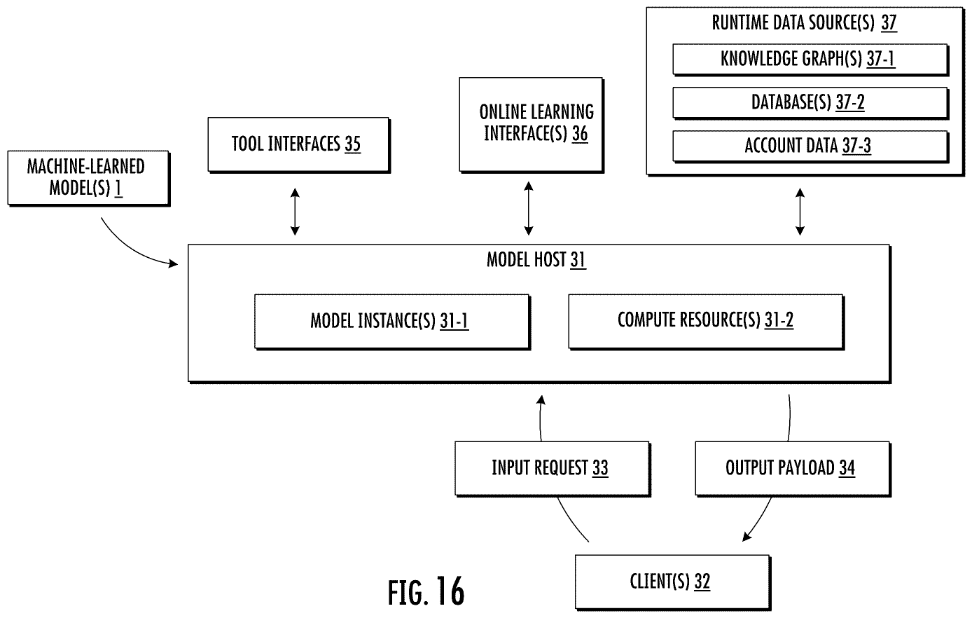

FIG. 16 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 2 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on the same device or system as client(s) 32. Model host 31 can be a machine-learning service that runs on-device to provide machine-learning functionality to one or multiple applications operating on a client device, which can include an application implementing client(s) 32. Model host 31 can be a part of the same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also share model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g. one or more images or videos), the output comprises compressed visual data, and the task is a visual data compression task. In another example, the task may comprise generating an embedding for input data (e.g. input audio or visual data). In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction following the task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

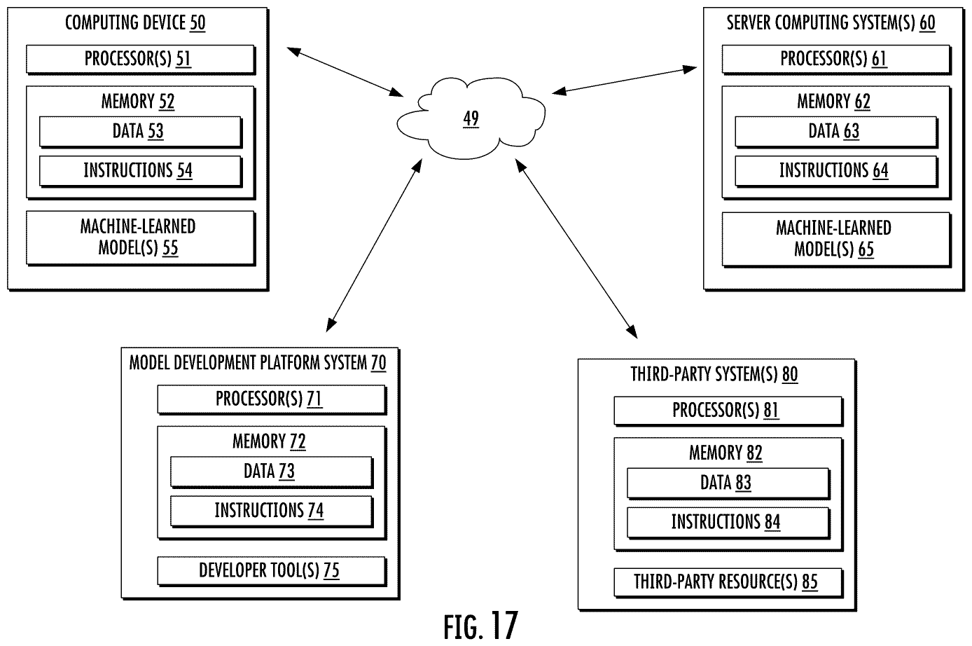

FIG. 17 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 17 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provided that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 17 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

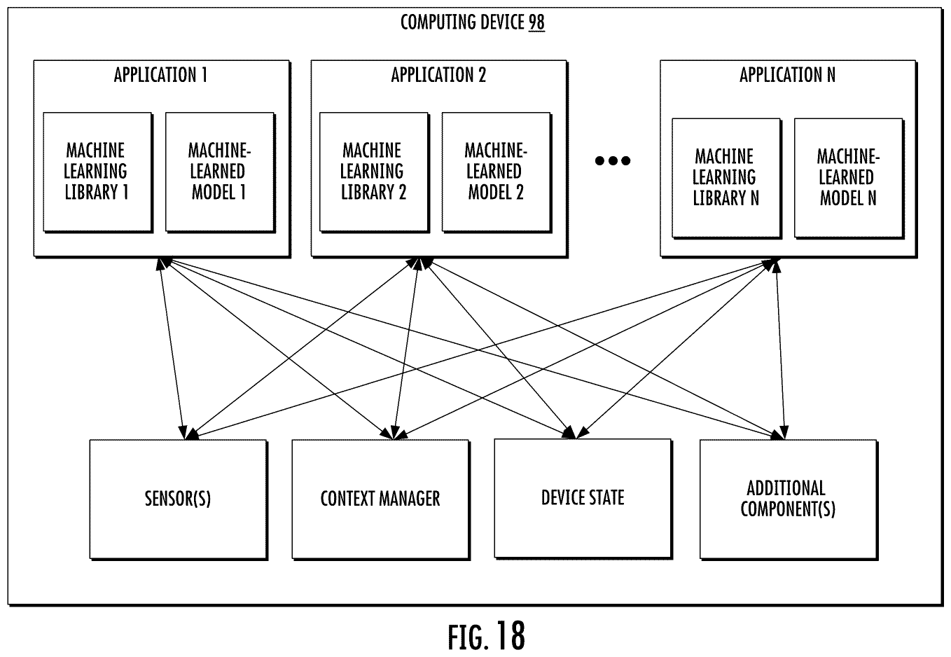

FIG. 18 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 18, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

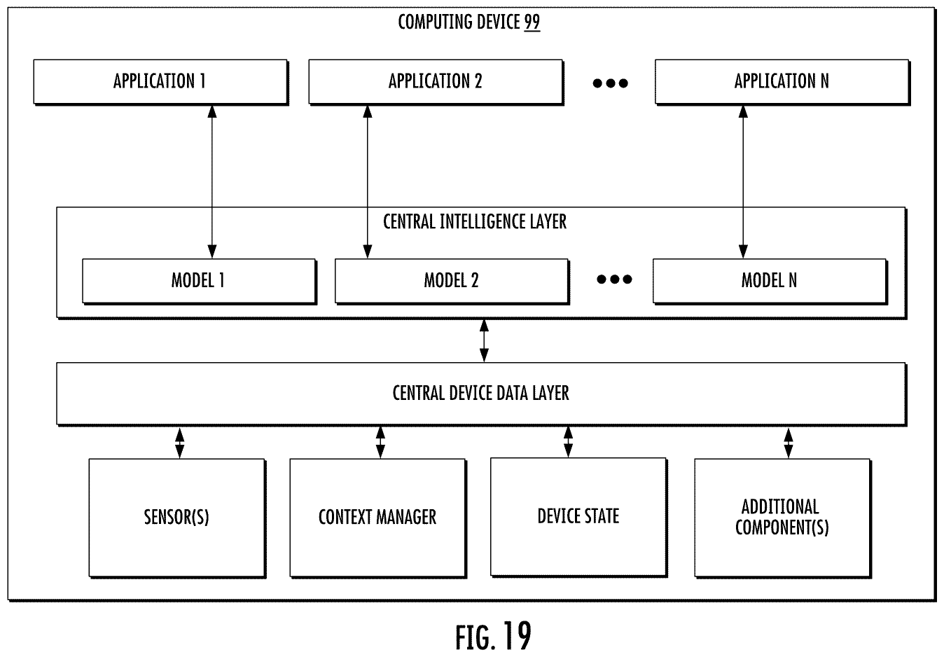

FIG. 19 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 19, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 19, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computing system, comprising:
one or more processors; and
one or more transitory or non-transitory computer-readable media storing instructions that are executable to cause the one or more processors to perform operations, the operations comprising:
obtaining display data associated with display content, wherein the display data comprises:
a temporally sequential set of frames; and
a first set of textual data in a first language;
processing, using a first machine-learning model, the display data to categorize portions of each frame of the temporally sequential set of frames as static regions or dynamic regions;
generating a second set of textual data in a second language based on a subset of the first set of textual data within the static regions of the display data;
modifying the display data based on the static regions and the second set of textual data by:
inpainting portions of the display content comprising the first set of textual data; and
rendering the second set of textual data in the portions that were inpainted.

2. The computing system of claim 1, wherein the operations further comprise processing the display data to generate an image patch grid associated with the temporally sequential set of frames.

3. The computing system of claim 2, wherein:
the image patch grid comprises a plurality of cells; and
processing the display data further comprises processing, using the first machine-learning model, the temporally sequential set of frames to identify:
a first subset of cells of the plurality of cells associated with the static regions of each frame with relation to the sequential set of frames; and
a second subset of cells of the plurality of cells associated with the dynamic regions of each frame with relation to the sequential set of frames.

4. The computing system of claim 1, wherein:
the temporally sequential set of frames comprises at least a first frame and a second frame; and
modifying the display data further comprises:
mapping the static regions of the first frame to the static regions of the second frame;
inpainting portions of the second frame comprising the first set of textual data; and
rendering the second set of textual data in the portions of the second frame that were inpainted.

5. The computing system of claim 4, wherein:
the mapping further comprises mapping the first subset of cells associated with the first frame to the first subset of cells associated with the second frame.

6. The computing system of claim 1, wherein generating a second set of textual data comprises:
transmitting the first set of textual data to a server computing system;
instructing the server computing system to generate the second set of textual data based on the first set of textual data; and
instructing the server computing system to transmit the second set of textual data to the one or more processors.

7. The computing system of claim 1, wherein the operations further comprise:
receiving a user inquiry associated with at least one frame within the temporally sequential set of frames ;
generating a query response based on the user inquiry, where the query response is in the second language; and
overlaying the query response over the modified display data.

8. The computing system of claim 1, wherein obtaining the display data comprises processing the temporally sequential set of frames to identify the first set of textual data.

9. The computing system of claim 1, wherein the static regions comprise portions of display content for which pixel values remain within a predetermined threshold across two or more frames within the temporally sequential set of frames based on a pixel-wise comparison.

10. The computing system of claim 1, wherein categorizing portions of each frame of the temporally sequential set of frames as the static regions further comprise:
detecting, using the first machine-learning model, a positional change of the first set of textual data across one or more frames within the temporally sequential set of frames;
mapping the first set of textual data from a first position in a first frame to a second position in a subsequent frame of the temporally sequential set of frames; and
categorizing the first position within the first frame and the second position within the subsequent frame as static regions.

11. A computer implemented method, the method comprising:
obtaining, using a computing device, display data associated with display content, wherein the display data comprises:
a temporally sequential set of frames; and
a first set of textual data in a first language;
processing, using a first machine-learning model operating on the computing device, the display data to categorize portions of each frame of the temporally sequential set of frames as static regions or dynamic regions, wherein the static regions comprise display content that has shifted position across one or more frames within the temporally sequential set of frames while retaining its original content;
generating, using the computing device, a second set of textual data in a second language based on a subset of the first set of textual data within the static regions of the display data; and
modifying, using the computing device, the display data based on the static regions and the second set of textual data by:
inpainting portions of the display content comprising the first set of textual data; and
rendering the second set of textual data in the portions that were inpainted.

12. The method of claim 11, wherein the method further comprises processing, using the computing device, the display data to generate an image patch grid associated with the temporally sequential set of frames.

13. The method of claim 12, wherein:
the image patch grid comprises a plurality of cells; and
processing the display data further comprises processing, using the first machine-learning model, the temporally sequential set of frames to identify:
a first subset of cells of the plurality of cells associated with the static regions of each frame with relation to the sequential set of frames; and
a second subset of cells of the plurality of cells associated with the dynamic regions of each frame with relation to the sequential set of frames.

14. The method of claim 11, wherein:
the temporally sequential set of frames comprises at least a first frame and a second frame; and
modifying the display data further comprises:
mapping the static regions of the first frame to the static regions of the second frame;
inpainting portions of the second frame comprising the first set of textual data; and
rendering the second set of textual data in the portions of the second frame that were inpainted.

15. The method of claim 11, wherein generating a second set of textual data comprises:
transmitting the first set of textual data to a server computing system;
instructing the server computing system to generate the second set of textual data based on the first set of textual data; and
instructing the server computing system to transmit the second set of textual data to the computing device.

16. The method of claim 11, wherein the method further comprises:
receiving, using the computing device, a user inquiry associated with at least one frame within the temporally sequential set of frames;
generating, using the computing device, a query response based on the user inquiry, where the query response is in the second language; and
overlaying, using the computing device, the query response over the modified display data.

17. The method of claim 16, wherein generating the query response further comprises:
generating an image segment from the at least one frame based on the user inquiry;
processing the image segment using a search engine to determine one or more search results; and
generating the query response based on the one or more search results.

18. The method of claim 11, wherein the static regions comprise portions of display content for which pixel values remain within a predetermined threshold across two or more frames within the temporally sequential set of frames based on a pixel-wise comparison.

19. The method of claim 11, wherein categorizing portions of each frame of the temporally sequential set of frames as the static regions further comprise:
detecting, using the first machine-learning model, a positional change of the first set of textual data across one or more frames within the temporally sequential set of frames;
mapping the first set of textual data from a first position in a first frame to a second position in a subsequent frame of the temporally sequential set of frames; and
categorizing the first position within the first frame and the second position within the subsequent frame as static regions.

20. A computing system, comprising:
one or more processors; and
one or more transitory or non-transitory computer-readable media storing instructions that are executable to cause the one or more processors to perform operations, the operations comprising:
obtaining a first frame descriptive of display content provided for display by a user computing device;
obtaining a translation request;
processing, using an image augmentation model, the first frame to generate an augmented first frame based on the translation request, wherein processing the first frame comprises:
identifying a first set of textual data within the first frame;
processing the first set of textual data within the first frame to generate a second set of textual data in a language that differs from the first set of textual data; and
generating the augmented first frame by replacing the first set of textual data with the second set of textual data;
determining a navigation event has occurred based on a change in the display content between the first frame and a plurality of subsequent frames;
determining the navigation event has ended based on determining a stagnant state has been reached within the plurality of subsequent frames by analyzing pixel differences across the plurality of subsequent frames based on the change in the display content;
obtaining a particular frame from the plurality of subsequent frames, wherein the particular frame occurred after the navigation event ended;
processing, using the image augmentation model, the particular frame to generate an augmented particular frame based on the translation request, wherein generating the augmented particular frame comprises:
identifying a third set of textual data within the particular frame;
processing the third set of textual data within the particular frame to generate a fourth set of textual data in a language that differs from the third set of textual data, wherein the second set of textual data and the fourth set of textual data are in a same language; and
generating the augmented particular frame by replacing the third set of textual data with the fourth set of textual data.
